(19) United States
(12) Patent Application Publication
(10) Pub. No.: US 2011/0049894 A1
(43) Pub. Date: Mar. 3, 2011

(54) Electricity Generating Assembly

(76) Inventor: William M. Green, Robersonville, NC (US)

(21) Appl. No.: 12/907,579

(22) Filed: Oct. 19, 2010

Related U.S. Application Data
(63) Continuation-in-part of application No. 11/867,436, filed on Oct. 4, 2007, now Pat. No. 7,816,802.
(60) Provisional application No. 60/849,842, filed on Oct. 6, 2006.
(60) Provisional application No. 60/915,591, filed on May 2, 2007.

(51) Int. Cl. H02K 7/18

(52) U.S. Cl. 290/52

(57) ABSTRACT

An electricity generating assembly includes a first turbine having a first plurality of fan blades and a second turbine having a second plurality of fan blades. A first rotor is connected to the first turbine and rotatable with the first turbine. A second rotor is connected to the second turbine and is rotatable with the second turbine. The first and second turbines are rotatably connected to a shaft such that rotation of the first and second turbines cause rotation of the shaft, wherein the first and second turbines rotate in opposite directions.

### CROSS REFERENCE TO RELATED APPLICATIONS

This application is a continuation-in-part of U.S. patent application Ser. No. 11/867,436, now U.S. Pat. No. 7,816,802, filed Oct. 4, 2007, which claims the benefit under 35 U.S.C. §119(e) of provisional application Ser. No. 60/849,842, filed Oct. 6, 2006 and 60/915,591, filed May 2, 2007, the entire disclosures of both of which are hereby incorporated by reference.

### FIELD OF THE INVENTION

The present invention relates to an electricity generating assembly that utilizes fluid currents or flow to produce electricity. More particularly, the present invention relates to a wind generator assembly having an electrically driven shutter assembly. Furthermore, the present invention relates to a electricity generating assembly that uses water to produce electricity. Still more particularly, the present invention relates to an electricity generating assembly that is remotely operable.

### BACKGROUND OF THE INVENTION

Wind generators have long existed in which electricity is produced by rotation of a fan by wind. If the wind generators have no protection or shielding, such that high winds and foreign objects, such as birds, the blades and other internals of the wind generator can be damaged causing loss of power.

Existing wind generators have been provided with shutters to protect blades and other components of the wind generator from possible damage. The shutter assemblies are driven by the wind, such that the shutter assemblies are open until winds occur that are strong enough to close the shutter assemblies.

However, the assemblies of such methods of protecting wind generators often fail to close when subjected to high winds, thereby failing to protect the wind generators. U.S. Pat. No. 177,597 to Ward and U.S. Pat. No. 3,793,530 to Carter describe wind turbine generators having weighted shutters that are closed by wind.

Another problem with existing shuttered wind generators is that closure of the shutters is predetermined at a fixed wind condition, and there is no ability to operate the shutter assemblies under variable conditions.

### SUMMARY OF THE INVENTION

It has now been found that by controlling movement of the shutters for an electricity generating assembly by an electronic motor, the shutters may be opened and closed under variable conditions independently of the shutter structure design.

In accordance with the present invention, a fluid-driven electricity generating assembly includes a plurality of rotatable fan blades, a generator connected to the plurality of fan blades to produce electricity based on rotation of the plurality of fan blades, and a plurality of shutters surrounding the plurality of fan blades. The plurality of shutters are movable between a first position in which the plurality of shutters are open to allow access to the plurality of fan blades and a second position in which the plurality of shutters are closed to substantially prevent access to the plurality of fan blades. A motor is connected to the plurality of shutters to move the plurality of shutters between the first and second positions.

The exemplary embodiments of the present invention relate to an electricity generating assembly that generates electricity from wind and/or water currents. The electrically operated shutter assembly prevents high winds, water currents and foreign objects, such as birds, from damaging the fan blades. Additionally, a sensor may be connected to a motor to close the shutters due to high winds or other environmental conditions that could damage the fan blades. Gearing is connected between the motor and the shutter assembly to move the plurality of shutters in unison.

In an exemplary embodiment of the present invention an electricity generating assembly includes a plurality of rotatable fan blades. A generator is connected to the plurality of fan blades to convert rotation of the fan blades into electricity. A plurality of shutters surround the plurality of fan blades. The plurality of shutters are movable between a first position in which said plurality of shutters are open to allow access to the plurality of fan blades and a second position in which the plurality of shutters are closed to substantially prevent access to the plurality of fan blades. A motor is connected to the plurality of shutters to move the plurality of shutters between the first and second positions.

In another exemplary embodiment of the present invention, a method of generating electricity includes providing an electricity generating assembly having a plurality of shutters surrounding a plurality of rotatable fan blades. The plurality of shutters are moved to a first position to subject the plurality of fan blades to a fluid current to rotate the plurality of fan blades to generate electricity. The plurality of shutters are moved to a second position to interrupt the fluid current access to the plurality of fan blades. The plurality of shutters are moved to a more open position after the sensor determines normal conditions.

According to another embodiment of the present invention, a pole-mounted wind generator assembly is provided in which the gearing is disposed between the fan blades and the generator. A further embodiment involves a stand-alone wind generator assembly in which the generator may be disposed within the fan blades and directly connected to a shaft to which the fan blades are connected. Alternatively, the generator for the stand-alone wind generator may be disposed outside of the fan blades, either connected to the fan blade shaft or offset from the fan blade rotation axis to increase the number of revolutions of the generator by a revolution of the fan blades. The stand-alone wind generator assemblies may be disposed in any desired location, such as a hilltop, roof top or open field.

Another advantage provided by the wind generator assembly according to the exemplary embodiments of the present invention is the ability to easily spread the production of electricity over a wide geographic area. Rather than relying on a single, central location for the supply of electricity, the present self-contained wind generator assemblies may be widely dispersed over a geographic area. An event that would shut down a single location supplying electricity, such as a tornado, hurricane or terrorist strike, would only minimally impact a widely dispersed wind generator assembly system according to exemplary embodiments of the present invention.

In another exemplary embodiment of the present invention, an electricity generating assembly includes counter-rotating turbines. The power coils and field coils rotate at approximately twice the rpm as with a single turbine, thereby generating smoother DC current or higher frequency AC current from lower wind speeds.

Objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is a perspective view of an electricity generating assembly according to an exemplary embodiment of the present invention;

FIG. 2 is an exploded perspective view of the electricity generating assembly of FIG. 1;

FIG. 3 is an elevational view in partial cross section of an electricity generating assembly according to an exemplary embodiment of the present invention;

FIG. 4 is a bottom plan view of the electricity generating assembly of FIG. 3;

FIG. 5 is a top plan view of a fan plate of FIG. 3;

FIG. 6 is a top plan view of an upper bearing plate and upper bearing assembly of FIG. 3;

FIG. 7A is an elevational view of a shutter control band and shutters of FIG. 3;

FIG. 7B is a top plan view of the shutter control band of FIG. 7A, including a shutter motor and shutter drive gear;

FIG. 8 is an elevational view in partial cross section of a shutter bearing assembly of FIG. 3, including a shutter control band;

FIG. 9 is an enlarged view of the shutter bearing assembly and shutter drive shaft and shutter drive gear of FIG. 3;

FIGS. 10A and 10B are schematic illustrations of a plurality of electricity generating assemblies connected to a power distribution system;

FIG. 11 is an elevational view in partial cross section of an electricity generating assembly according to another exemplary embodiment of the present invention in which a generator is disposed within a plurality of fan blades;

FIG. 12 is an elevational view of an electricity generating assembly according to another exemplary embodiment of the present invention in which a generator is disposed externally of a plurality of fan blades;

FIG. 13 is an elevational view of an electricity generating assembly including an air flow control assembly;

FIG. 14 is a top plan view of the electricity generating assembly of FIG. 13;

FIG. 15 is an elevational view of an electricity generating assembly having a weighted wheel mounted on a generator shaft;

FIG. 16 is a top plan view of an electricity generating assembly in which the shutter assembly is mounted further away from the plurality of fan blades;

FIG. 17 is an elevational view of an electricity generating assembly mounted on a support including a transformer;

FIG. 18 is an elevational view of an electricity generating assembly mounted in water and above the water surface;

FIG. 19 is an elevational view of an electricity generating assembly movably mounted to a support such that the electricity generating assembly may be raised above the water surface;

FIG. 20 is an elevational view of an electricity generating assembly mounted on a support underwater;

FIG. 21 is a top plan view of an electricity generating assembly mounted across the width of a waterway;

FIGS. 22 and 23 are top plan views of a shutter assembly showing various shutter positions between open and closed;

FIGS. 24-26 are side elevational views of a shutter in open and closed positions;

FIG. 27 is a side elevational view of electricity generating assemblies harnessing the power of both wind and water;

FIG. 28 is a side elevational view of the assembly of FIG. 27 showing a frame to facilitate mounting an electricity generating assembly to a support;

FIG. 29 is a side elevational view of electricity generating assemblies harnessing the power of both wind and water and a solar panel to generate electricity from solar power;

FIG. 30 is a side elevational view of the shaft, generator and bearing assembly of the electricity generating assembly of FIG. 27;

FIG. 31 is a side elevational view illustrating electricity generating assemblies of various sizes mounted on a building;

FIG. 32 is an exploded perspective view of an electricity generating assembly according to another exemplary embodiment of the present invention including a counter rotating turbine;

FIG. 33 is a perspective view of the rotating core transformer of FIG. 32;

FIG. 34 is an exploded perspective view of an electricity generating assembly according to another exemplary embodiment of the present invention including a rotor;

FIG. 35 is an exploded perspective view of an electricity generating assembly according to another exemplary embodiment of the present invention including a brush ring;

FIG. 36 is an enlarged perspective view of the brush ring of FIG. 35;

FIG. 37 is an exploded perspective view of an electricity generating assembly according to another exemplary embodiment of the present invention including inertia disks;

FIG. 38 is an enlarged perspective view of the inertia disks of FIG. 37;

FIG. 39 is a perspective view of the electricity generating assembly of FIG. 32;

FIG. 40 is a perspective view of the electricity generating assembly of FIG. 32 disposed in a building;

FIG. 41 is a perspective view of an electricity generating assembly according to another exemplary embodiment of the present invention disposed in a dam;

FIG. 42 is a perspective view of the electricity generating assembly of FIG. 41;

FIG. 43 is a top plan view of the electricity generating assembly of FIG. 42;

FIG. 44 is an enlarged perspective view of the electricity generating assembly of FIG. 42;

FIG. 45 is a schematic diagram of the production of electricity by an exemplary electricity generating assembly;

FIG. 46 is a perspective view of a rotor; and

FIG. 47 is a perspective view of upper and lower turbines disposed on separate rotating shafts.

Throughout the drawings, like reference numerals will be understood to refer to like parts, components and structures.

### DETAILED DESCRIPTION OF EXEMPLARY EMBODIMENTS

The present invention is described more fully with reference to the accompanying drawings, in which exemplary embodiments of the invention are shown. The present invention may, however, be embodied in many different forms and should not be construed as being limited to the exemplary embodiments set forth herein; rather, these exemplary embodiments are provided so that this disclosure is thorough and complete, and conveys the concept of the invention to those skilled in the art.

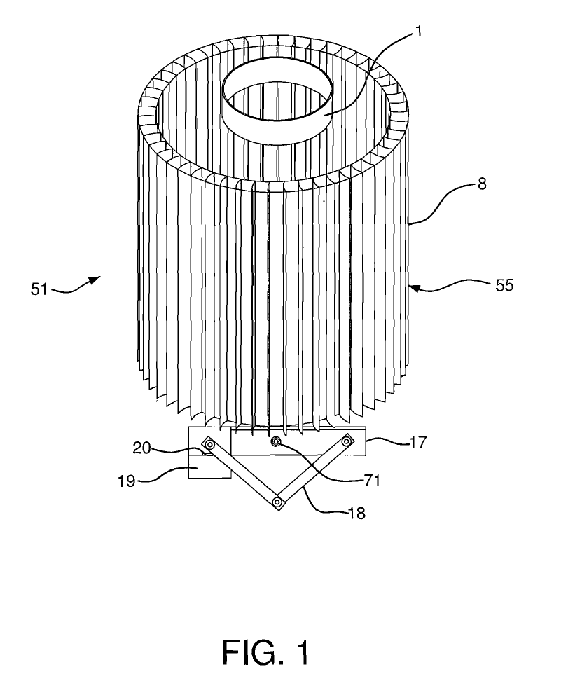

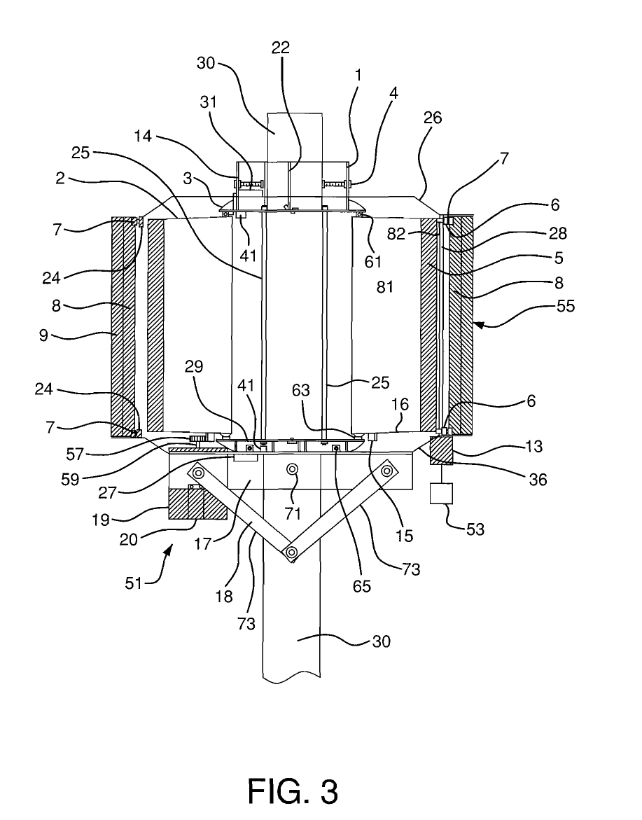

In a first exemplary embodiment of the present invention, the electricity generating assembly 55 is mounted to a pole 30 and the generator 19 is disposed externally of the plurality of fan blades 5, as shown in FIGS. 1 and 3. The generator 19 may include a gear box, transmission, and/or other suitable gear and power transmitting assemblies

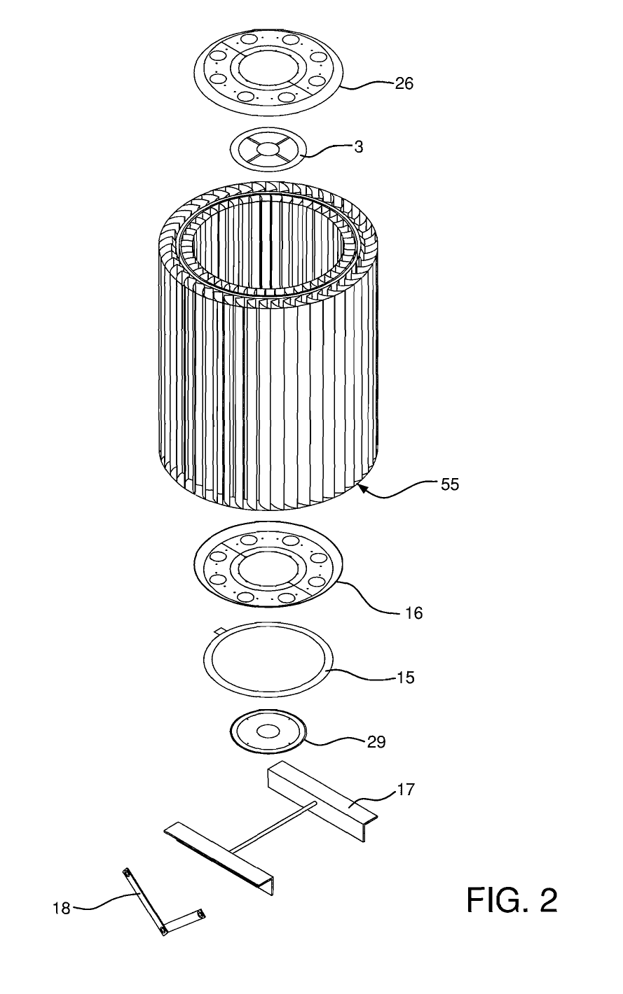

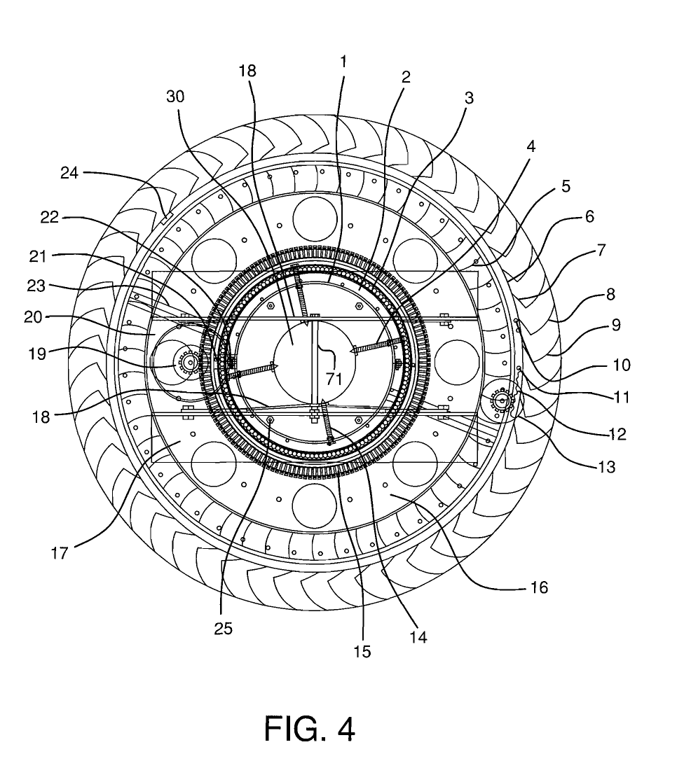

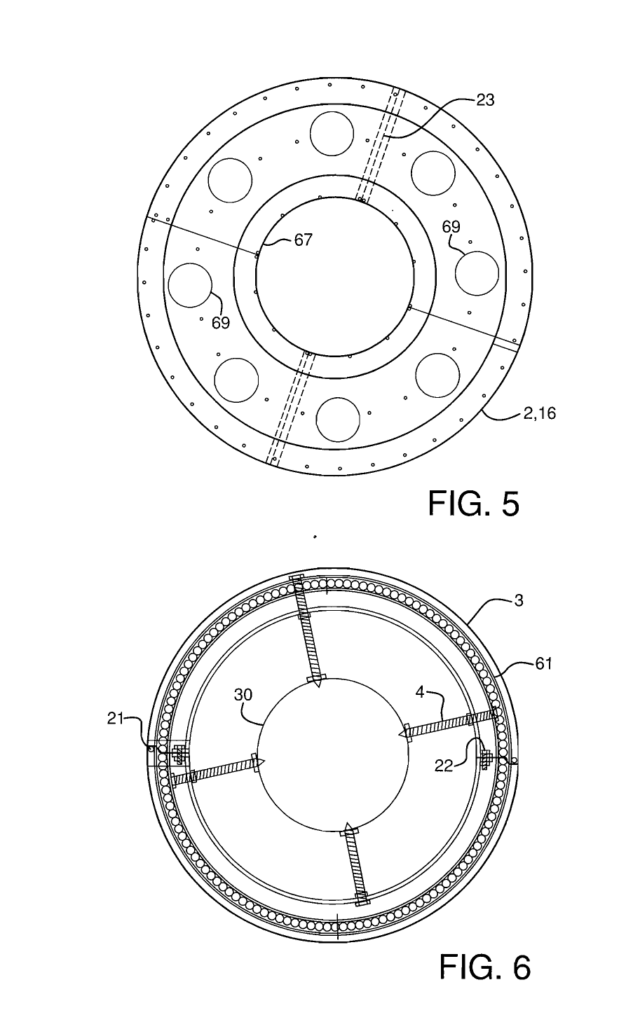

As shown in FIGS. 1-4, the electricity generating assembly 55 is mounted to a support, such as a telephone pole 30. A plurality of fan blades 5 are disposed between an upper bearing plate 3 and a lower bearing plate 29. An upper fan blade assembly 61 is disposed between the plurality of fan blades 5 and the upper bearing plate 3 and a lower fan blade assembly 63 is disposed between the plurality of fan blades 5 and the lower bearing plate 29, thereby facilitating rotation of the fan blades. An upper bearing lubricator 31 and a lower bearing lubricator 27 are connected to the upper and lower bearing assemblies 61 and 63, respectively, as shown in FIG. 3 to lubricate the bearing assemblies. Portions of the upper and lower bearing plates 3 and 29 may be connected by a splice 21, as shown in FIGS. 4 and 6. A generator drive gear 15 is secured to the lower end of the plurality of fan blades, as shown in FIGS. 2-4.

A lower fan plate 16 is connected to a lower end of the plurality of fan blades 5, as shown in FIGS. 2-4. As shown in FIG. 5, the lower fan plate 16 has an opening 67 to receive the pole 30. A plurality of air openings 69 in the lower fan plate 16 allow air that has passed through the plurality of fan blades 5 to exit the electricity generating assembly 55. A generator drive gear 15 is secured to the lower fan plate 16, as shown in FIG. 3. The lower fan blade bearings 63 are preferably disposed between the lower fan plate 16 and the lower bearing plate 29. As shown in FIGS. 4 and 5, a splice 23 may be used to join portions of the lower fan plate 16.

A lower cover 36 is connected between the lower bearing plate 29 and a mounting bracket 17, as shown in FIGS. 2 and 3. Preferably, a plurality of brackets 65 secure the lower cover 36 between the lower bearing plate 29 and the mounting bracket 17.

The mounting bracket 17 is secured to the support 30, as shown in FIGS. 1-4, by a fastener, which passes entirely through the support 30. A brace assembly 18 is secured to the mounting bracket 17 at opposite ends of the fastener 71. The brace assembly 18 has a plurality of arms 73 to further secure the electricity generating assembly 55 to the support 30.

The generator 19 is secured to the mounting bracket 17 by a generator mounting bracket 20, as shown in FIGS. 3 and 4. A generator shaft 59 is rotatably connected to the generator 19 and has a gear 57 at the exposed end of the generator shaft. The gear 57 engages the generator drive gear 15 such that rotation of the plurality of fan blades 5 results in rotation of the generator shaft, thereby generating electricity. The generator drive gear 15 may be connected to the fan blades at any suitable position. Disposing the generator drive gear 15 at an outer edge of the fan blades would provide more revolutions of the generator gear shaft per revolution of the fan blades than disposing the generator drive gear closer to an inner edge as shown in FIG. 3. Additional gears may be disposed between the generator drive gear 15 and the generator gear 57, thereby effecting the number of revolutions of the generator shaft per revolution of the fan blades.

An upper fan plate 2 is connected to an upper end of the plurality of fan blades 5, as shown in FIGS. 2-4. As shown in FIG. 5, the upper fan plate 2 is substantially identical to the lower fan plate 16, and has an opening 67 to receive the pole 30. A plurality of air openings 69 in the lower fan plate 16 allow air that has passed through the plurality of fan blades 5 to exit the electricity generating assembly 55. The upper fan blade bearings 61 are preferably disposed between the upper fan plate 2 and the upper bearing plate 3. As shown in FIGS. 3 and 5, a splice 23 may be used to join portions of the upper fan plate 2.

An upper fan cover 26 is connected between the upper bearing plate 3 and a top mounting assembly 1, as shown in FIGS. 2 and 3. Preferably, a plurality of brackets 65 secure the upper bearing plate 3, the top mounting assembly 1 and the upper fan cover 26. A plurality of fasteners 4 and nuts 14 secure the top mounting assembly 1 to the support 30, as shown in FIGS. 3 and 4.

A plurality of stabilizer rods 25 are connected between the upper and lower bearing plates 3 and 29 to stably support the wind generator assembly 5 on the support 30.

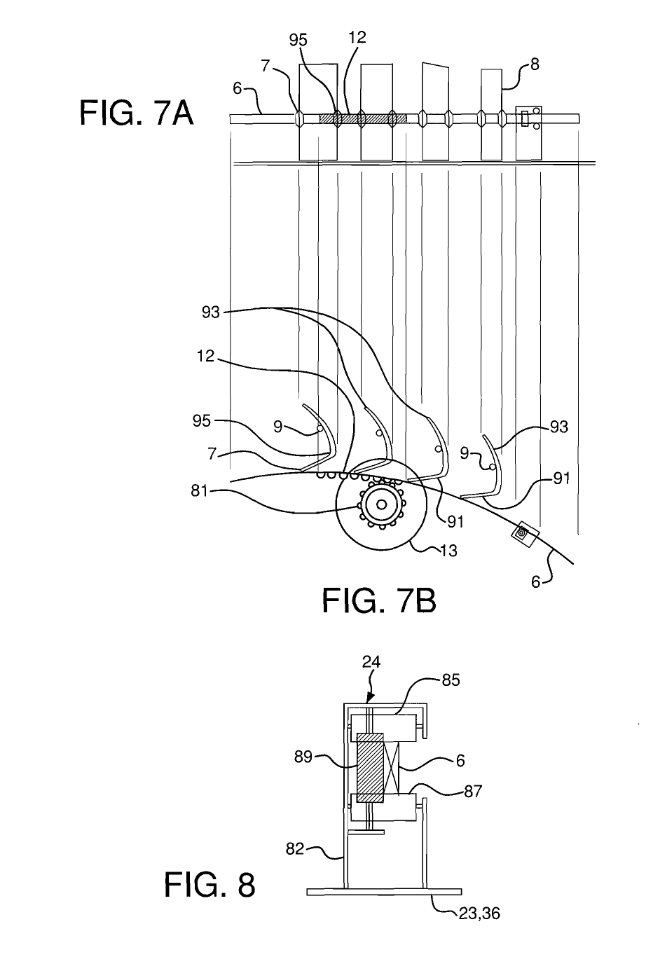

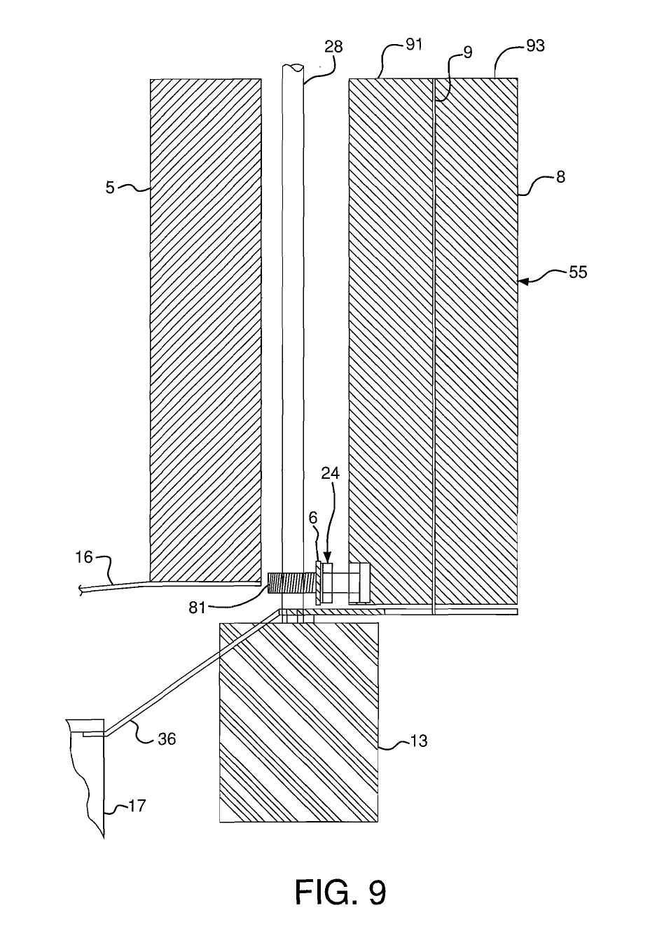

A shutter drive rod 28 extends upwardly from the shutter drive motor 13, which is connected to lower fan cover 36, as shown in FIGS. 4 and 9. An upper end of the shutter drive rod 28 is rotatably received by the upper fan cover 26. A shutter drive gear 81 is connected to the shutter drive rod 28, as shown in FIGS. 7B and 9. A shutter control band 6 is disposed is a shutter bearing assembly 24, as shown in FIGS. 8 and 9. A portion 12 of the shutter control band 6 has teeth that engage the shutter drive gear 81. Thus, rotation of the shutter drive gear 81 by the shutter drive motor 13 results in rotation of the shutter control band 6, thereby moving the shutter assembly 55 between open and closed positions. The motor 13 is preferably battery powered, but may be powered in any suitable method, such as solar powered or powered by the generator 19.

The shutter bearing assembly 24 includes first and second bearings 85 and 87 rotatably disposed within the bearing housing 82, as shown in FIG. 8. A third bearing 89 is rotatably disposed within the bearing housing 82 such that its rotation axis is substantially perpendicular to the rotation axes of the first and second bearings 85 and 87. The shutter control band 6 is rotatably received within the bearing housing 82 by the first, second and third bearings 85, 87 and 89 to facilitate rotation of the shutter control band 6. As shown in FIG. 3, first and second shutter drive gears 81 and 82 may be disposed proximal first and second ends of the shutter drive rod 28. A pair of substantially similar shutter bearing assemblies 24, including shutter control bands 6, are disposed to engage the first and second shutter drive gears.

As shown in FIGS. 7A and 7B, the shutters 8 of the shutter assembly are connected by hinge pins 7 to the shutter control band 6. As shown in FIGS. 7B and 9, the shutters 8 may have a first portion 91 and a second portion 93 rotatably connected by a hinge 95. A hinge 7 rotatably connects the first portion 91 of the shutter 8 to the shutter control band 6. As shown in FIG. 3, upper and lower hinges 7 and 95 are used when the wind generator assembly 51 has upper and lower shutter control bands 6. As shown in FIG. 16, the shutter assembly 55 may be disposed further away from the plurality of fan blades 5, thereby allowing for the use of larger shutters 8. A larger shutter 8 allows the electricity generating assembly 51 to capture more wind. Moreover, the larger shutter 8 reduces the static pressure within the electricity generating assembly 51, thereby reducing drag and increasing the efficiency of the wind generator assembly. Additionally, a larger shutter 8 has more surface area that may be utilized for electricity generation, such as by disposing a solar device thereon. For example, solar tape may be disposed on the shutters 8, thereby allowing electricity to be generated from captured sunlight, in addition to generating electricity from captured wind.

A shutter pivot rod 9 is connected between the upper and lower fan covers 26 and 36, as shown in FIGS. 3 and 9. A shutter pivot rod 9 is used for each shutter 8. The shutter pivot rod 9 guides the second portion 93 of each shutter 8 as the shutter moves between open and closed positions, as shown in FIG. 7B. Shutter stops 10 and 11 are disposed on the shutter control band 6 to prevent rotation of the shutter gear 81 beyond the fully opened and fully closed positions.

A sensor 53 may be connected to the motor 13 to cause the motor to open and close the shutter assembly 55. The sensor 53 may be disposed to sense rotation of the plurality of fan blades 5 or to measure wind speed. The sensor 53 sends an appropriate signal to the motor 13 to open or close the shutter assembly 55 in response to the sensed value. Alternatively, the sensor 53 may be remotely controlled, such as by a global positioning system (GPS), to remotely open and close the shutter assembly 55 as desired.

Heat sensors 41, as shown in FIG. 3, may be disposed proximal the upper and lower fan blade bearings 61 and 63 such that the sensors detect overheating of the bearings that may lead to malfunction of the wind generator assembly 51. Heat sensors may also be disposed proximal any other bearing assemblies, gearing or motors of the wind generator assembly 51 to detect overheating thereof. The heat sensors may be remotely monitored, such as through a GPS system, so that a malfunctioning electricity generating assembly is quickly known and repair thereof may be initiated.

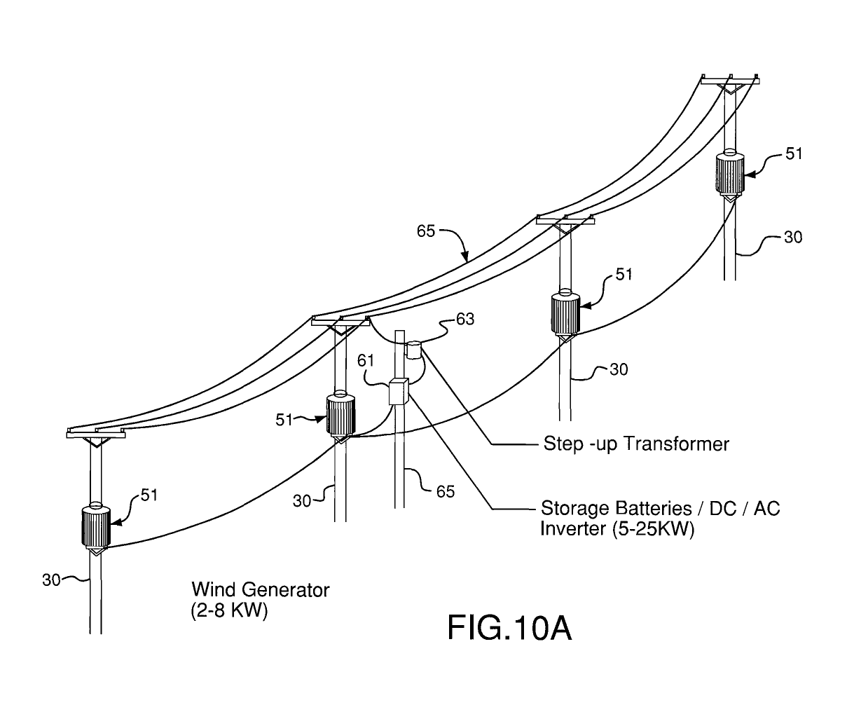

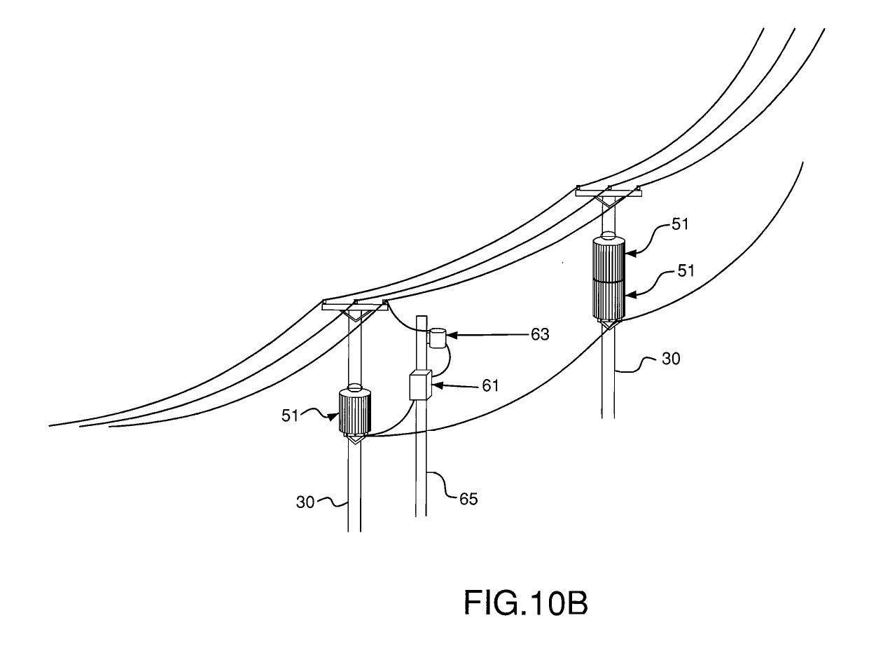

The wind generator assembly 51 is connected to a battery 61 for storage of generated electricity, as shown in FIGS. 10A and 10B. A plurality of electricity generating assemblies 51 may be connected to a single battery 61. A plurality of electricity generating assemblies 51 may be connected on a single support 30, as shown in FIG. 10B, to further increase the generation of electricity. Electricity is transferred from the battery 61 to a step-up transformer 63. Preferably, the battery 61 and the transformer are connected to a support 65. The transformer 63 is connected to an electrical distribution system 65 to provide a back-up power supply.

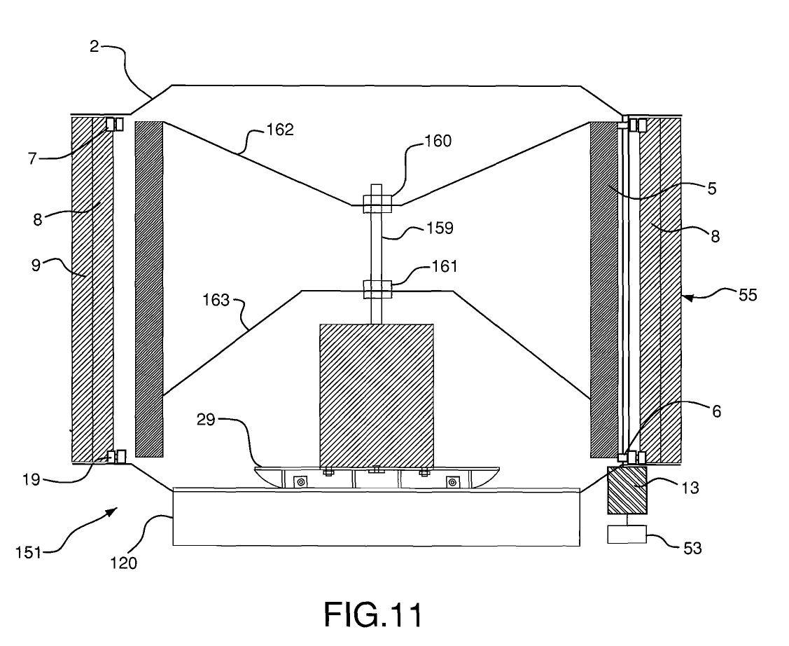

In another exemplary embodiment of the present invention, the generator 19 of the electricity generating assembly 151 is mounted within the plurality of fan blades 5, as shown in FIG. 11. The plurality of fan blades 5 are connected to the generator shaft 159 instead of using a generator drive gear 15 (FIG. 1). Mounting members 162 and 163 are connected to the plurality of fan blades 5 at opposite ends thereof, and a central portion of the mounting members are connected by mounting assemblies 160 and 161 to the gear shaft 159. Thus, rotation of the plurality of fan blades 5 results in rotation of the generator shaft 159, thereby generating electricity. The generator 19 is secured to the bottom bearing plate 29, which is secured to the mounting platform 120. The mounting platform 120 allows the electricity generating assembly 151 to be used as a free-standing unit.

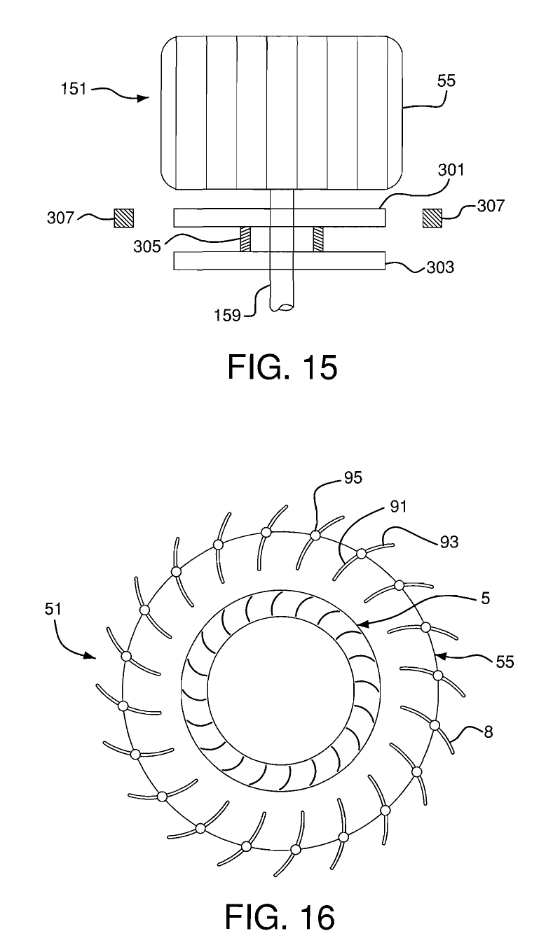

In another exemplary embodiment of the present invention, a weighted wheel 301 may be mounted on the generator shaft 159 to facilitate rotation, as shown in FIG. 15. The weighted wheel 301 imparts centrifugal momentum to the shaft 159, thereby facilitating rotation. A motor, similar to motor 13 shown in FIG. 11, may be connected to the plurality of fan blades 5 to facilitate starting rotation of the fan blades. Once sufficient momentum has been established to continue rotation of the fan blades 5, the motor may be disengaged. Additional wheels may be added to further impart momentum to the generator shaft 159. Furthermore, a gear assembly 305 may be disposed between first and second wheels 301 and 303 to cause the wheels to rotate in opposite directions, thereby substantially preventing any instability from being imparted to the shaft 159.

In another exemplary embodiment, a weighted wheel 301 is wired to act as an armature. A magnet 307 is disposed outside the wheel 303. Electricity is generated by the rotation of the wired wheel 301 in the magnetic field created by the magnet 307. The electricity generated by the wired wheel and magnet supplements the electricity generated by the fan blades. In still another exemplary embodiment, one wheel 301 may be wired to act as an armature, and the other wheel 303 may have a magnet such that electricity is generated by the rotation of the wheels in opposite directions.

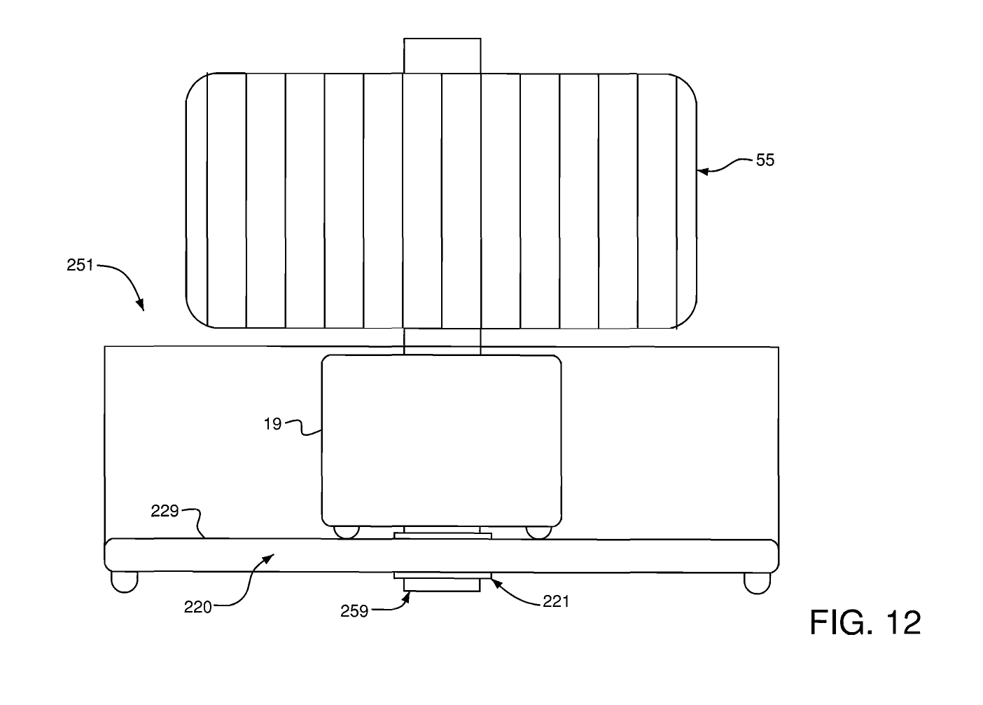

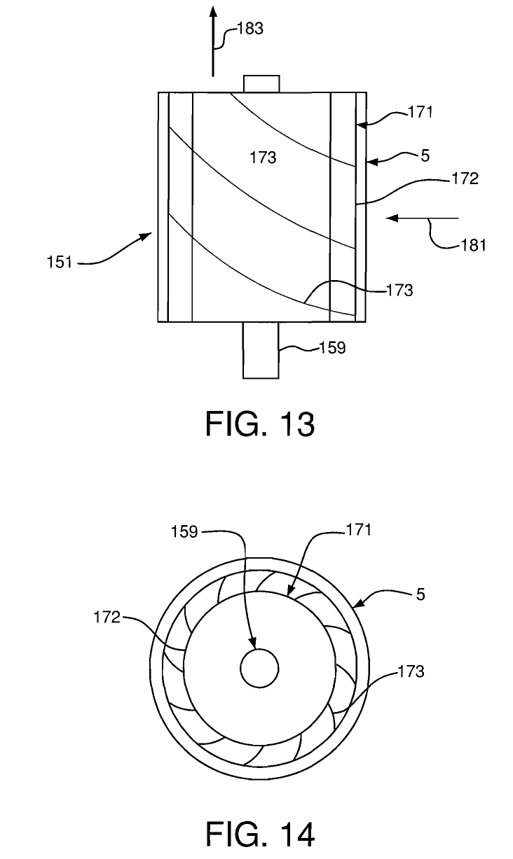

As shown in FIGS. 13 and 14, the electricity generating assembly 151 may include an air flow control assembly 171 disposed within the plurality of fan blades 5. The air flow control assembly includes a cylinder 172 to which a plurality of blades 173 are attached. The cylinder 172 may be connected to the shaft 159 in a similar manner as the plurality of fan blades 5, or may be connected to the electricity generating assembly 151 in any other suitable manner. The blades 173 direct incoming air 181 passing through the plurality of fan blades 5 out the top of the electricity generating assembly 151, as indicated by air flow arrow 183. This substantially prevents air from being trapped within the electricity generating assembly, which leads to creating drag on the generator such that the electricity generating assembly loses efficiency. Thus, by redirecting air out of the electricity generating assembly 151, the efficiency is increased. The wind control assembly 171 may be similar installed in the electricity generating assembly 51 of FIG. 3 and the electricity generating assembly 251 of FIG. 12.

In another exemplary embodiment of the present invention, the generator 19 of the electricity generating assembly 251 is mounted externally of the plurality of fan blades and connected to the generator shaft 259, as shown in FIG. 12. The plurality of fan blades may be connected to the generator shaft 259 in a substantially similar manner as shown in FIG. 11. The plurality of fan blades are connected to the generator shaft 259, instead of using a generator drive gear 15 (FIG. 1), such that rotation of the plurality of fan blades 5 results in rotation of the generator shaft 259, thereby generating electricity. The generator 19 is mounted on a bearing plate 229 of a housing 220. A bottom plate bearing 221 rotatably secures the generator shaft 259 to the bottom bearing plate 229 of the housing 220. Thus, the electricity generating assembly 259 may be used as a free-standing unit. Alternatively, the electricity generating assembly 251 may be connected to the plurality of fan blades by a gearing assembly substantially similar to the exemplary embodiment shown in FIG. 3. Thus, because the generator 19 is not axially connected by a shaft to the plurality of fan blades, that is, the axis of the fan blades and the axis of the generator are offset, the number of revolutions of the generator shaft per a single revolution of the plurality of fan blades is increased.

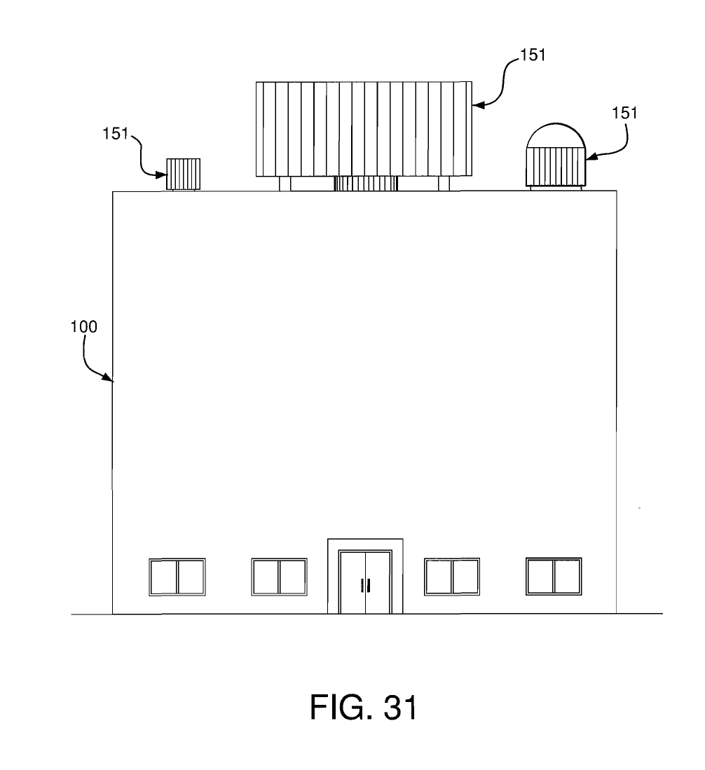

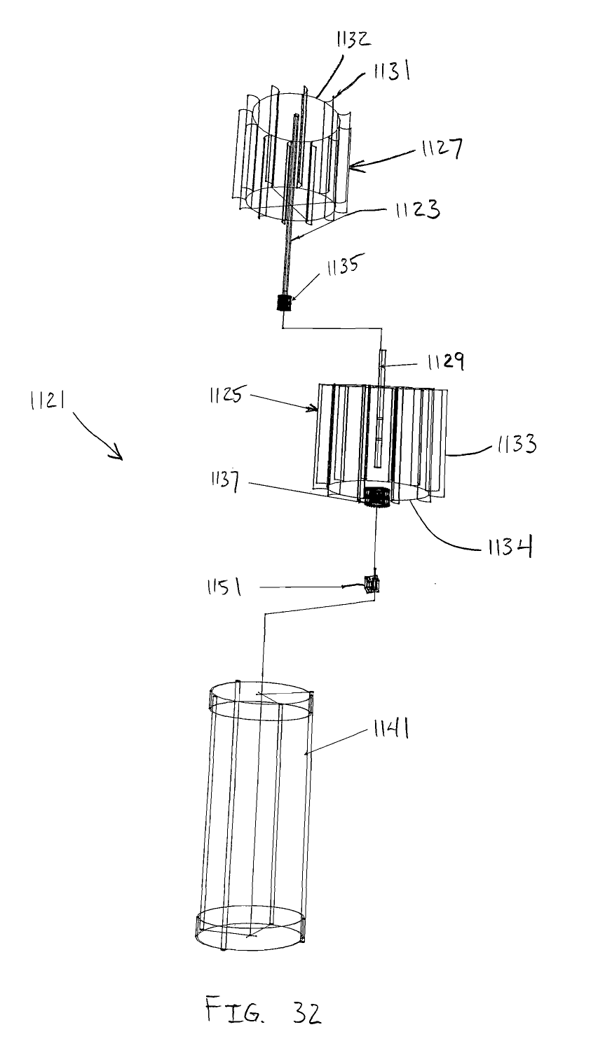

The stand-alone electricity generating assemblies 151 and 251 may be connected to storage batteries 61, as shown in FIGS. 10A and 10B. Alternatively, the stand-alone electricity generating assemblies may be directly connected to the power supply lines of commercial and residential buildings to provide back-up power supply. As shown in FIG. 31, electricity generating assemblies 151 of various sizes are mounted on a rooftop of a building 10. These electricity generating assemblies 151 may be directly connected to the power supply lines of the building 100 to provide back-up power supply. The size and configuration of the electricity generating assemblies 151 are controlled by several factors, including the size of the available mounting area of the building 100 and the back-up power supply requirements of the building 100.

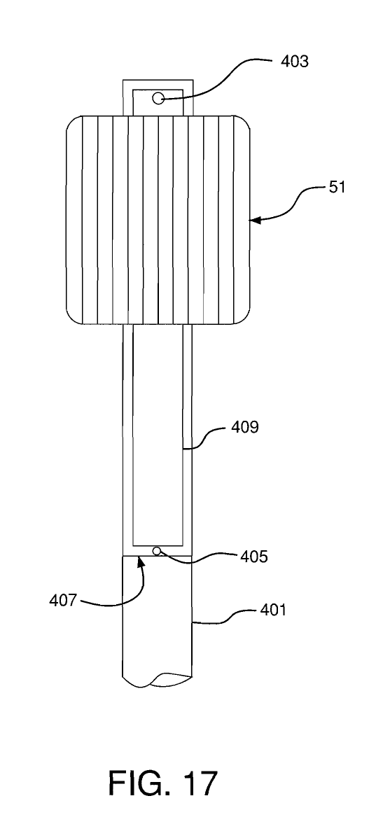

As shown in FIG. 17, an electricity generating assembly 51 is mounted on a support 401 that is substantially hollow. A battery 407 is formed in the hollow space in the support 401. An inlet 403 in the battery allows fluid, such as battery acid, to be filled in the battery 407 disposed in the support 401. A drain 405 allows fluid to be removed from the battery 407. A removable liner 409 may be disposed in the battery 407 to facilitate changing of the fluid. The battery 407 stores electricity generated by the electricity generating assembly 51.

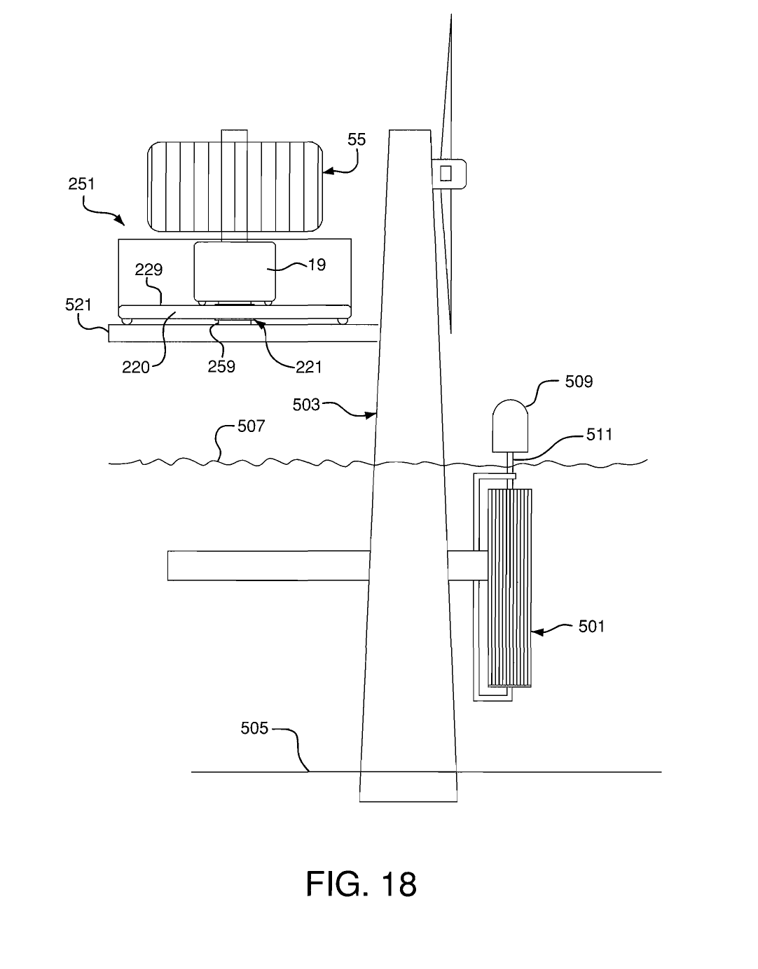

The electricity generated by the exemplary embodiments of the present invention is not limited solely to wind. As shown in FIG. 18, an electricity generating assembly 501 may be disposed beneath a water surface 507 to generate electricity due to water currents. A support 503, such as existing windmills disposed in an ocean floor 505, may receive one or more electricity generating assemblies 501. The generator and associated structure is disposed in a housing 509 mounted above the water surface 507, thereby providing easy access for maintenance. Alternatively, the generator shaft 511 may be a telescoping shaft such that the generator housing 509 may be disposed beneath the water surface 507 and then raised when maintenance is required. Thus, water flowing through the assembly 501 causes rotation of the fan blades, thereby generating electricity. The electricity generating assembly 501 is substantially similar to the afore-described electricity generating assemblies except that the fluid generating electricity is water rather than air. The plurality of fan blades may be made of plastic or other suitable material resistant to the growth of barnacles and other water formations.

As shown in FIG. 18, a first electricity generating assembly 251 (similar to the electricity generating assembly of FIG. 12) may be mounted to a support 521 above the water surface 507 to generate electricity by rotation of the fan blades by wind. A second electricity generating assembly 501 may be mounted beneath the water surface 507 to generate electricity due to water currents. Between the first and second electricity generating assemblies both wind and water currents are harnessed to generate electricity.

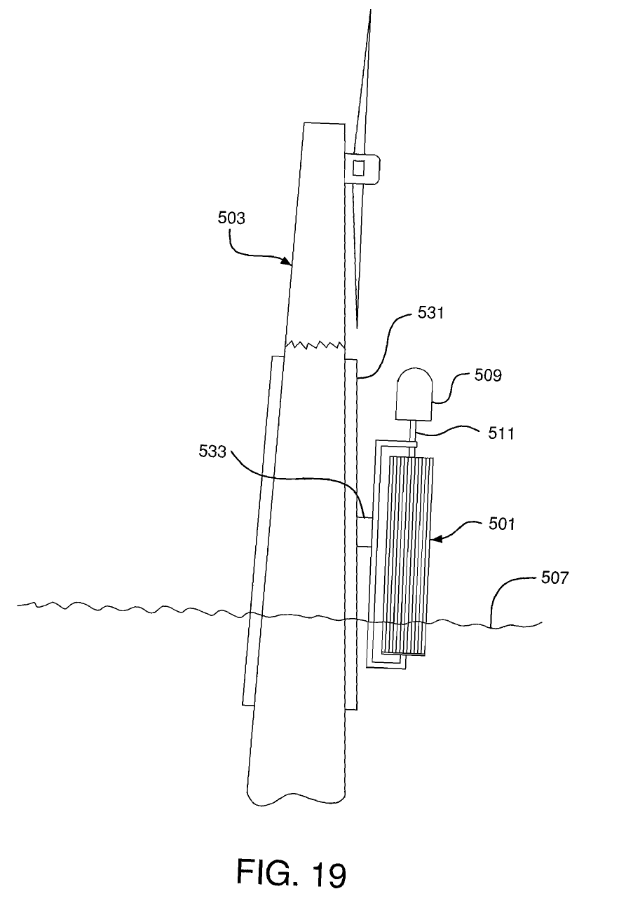

As shown in FIG. 19, the electricity generating assembly 501 has an arm 533 connected to a slotted sleeve 531 that is secured to the support 503. The arm 533 moves up and down within the slot in the sleeve 531 such that the electricity generating assembly 501 may be raised above the water surface 507. This allows the electricity generating assembly 501 to be disposed beneath the water surface 507, as shown in FIG. 18, such that electricity may be generated by water currents. The electricity generating assembly 501 may be raised above the water surface 507 to facilitate access thereto, such as for maintenance. Any suitable conventional method may be used to raise and lower the electricity generating assembly 501, such as mechanical or hydraulic methods.

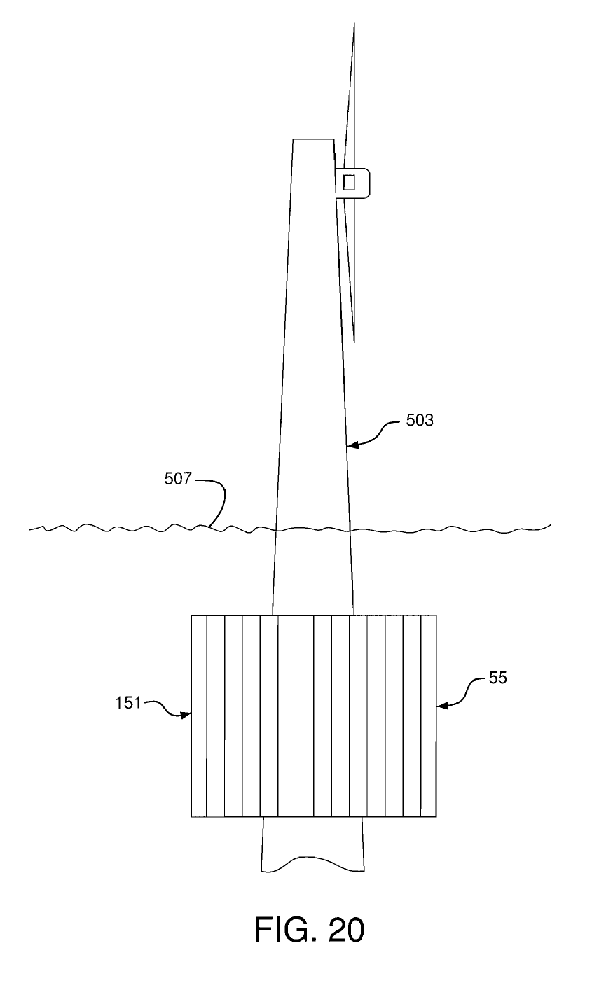

In another exemplary embodiment of the present invention, an electricity generating assembly 151, substantially similar to the electricity generating assembly shown in FIG. 11, is mounted to a support 503 underwater, as shown in FIG. 20. The support 503 may be an existing structure, such as a windmill. The electricity generating assembly 151 is self-contained such that all the components are housed within the shutter assembly 55. The electricity generating assembly may be raised out of the water in any suitable manner, such as mechanically or hydraulically.

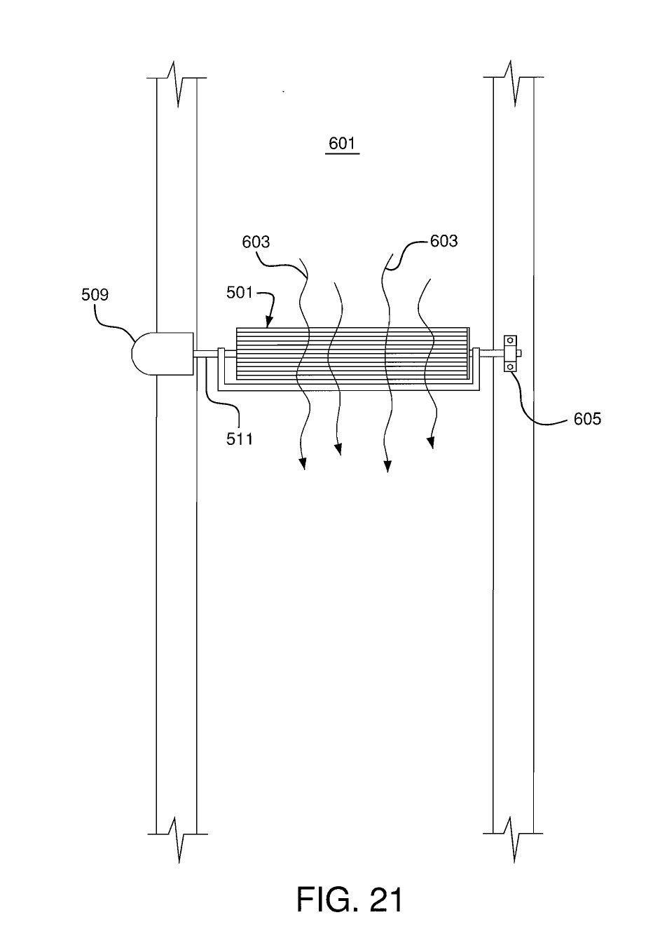

In another exemplary embodiment, as shown in FIG. 21, the electricity generating assembly 501 is mounted underwater in a waterway 601. This allows the electricity generating assembly 501 to be disposed beneath the water surface in the waterway 601, as shown in FIG. 21, such that electricity may be generated by water currents 603 flowing through the electricity generating assembly. Preferably, a first end of the generator shaft 511 is connected to the generator housing 509 mounted on one side of the waterway 601 and a second end of the generator shaft 511 is secured by a support 605 to the opposite side of the waterway. The waterway 601 may be any means through which water moves, such as, but not limited to, canals and dam spillovers and discharges.

An electricity generating assembly 51 according to an exemplary embodiment of the present invention may be easily and inexpensively assembled by adding a generator 19, a shutter assembly 55 and gearing for operation of the generator 19 and the shutter assembly 8 to a conventional “squirrel cage” fan. The shutter assembly 55 prevents foreign objects, such as birds or other debris, from damaging the plurality of fan blades 5. A sensor 53 may be connected to a motor 13 to close the shutter assembly 55 due to high winds or other environmental conditions that could damage the plurality of fan blades 5. The shutter bearing assembly 24 is connected between a shutter drive motor 13 and the shutter assembly 55 to move the plurality of shutters 8 between open and closed positions. A shutter drive rod 28 is disposed between upper and lower fan plates to facilitate opening and closing of the shutter assembly 55.

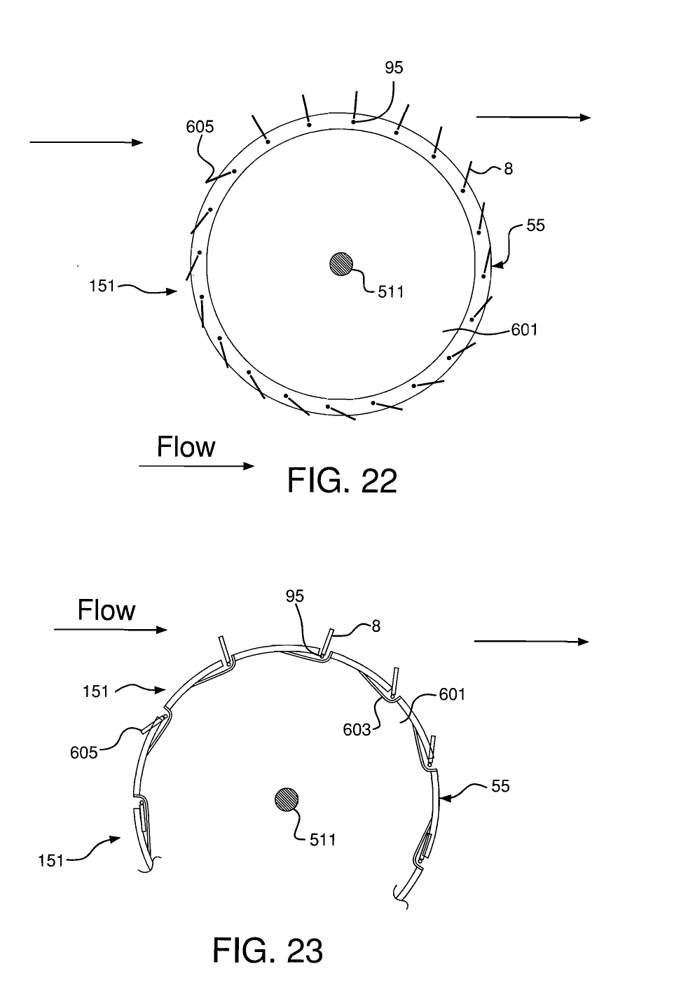

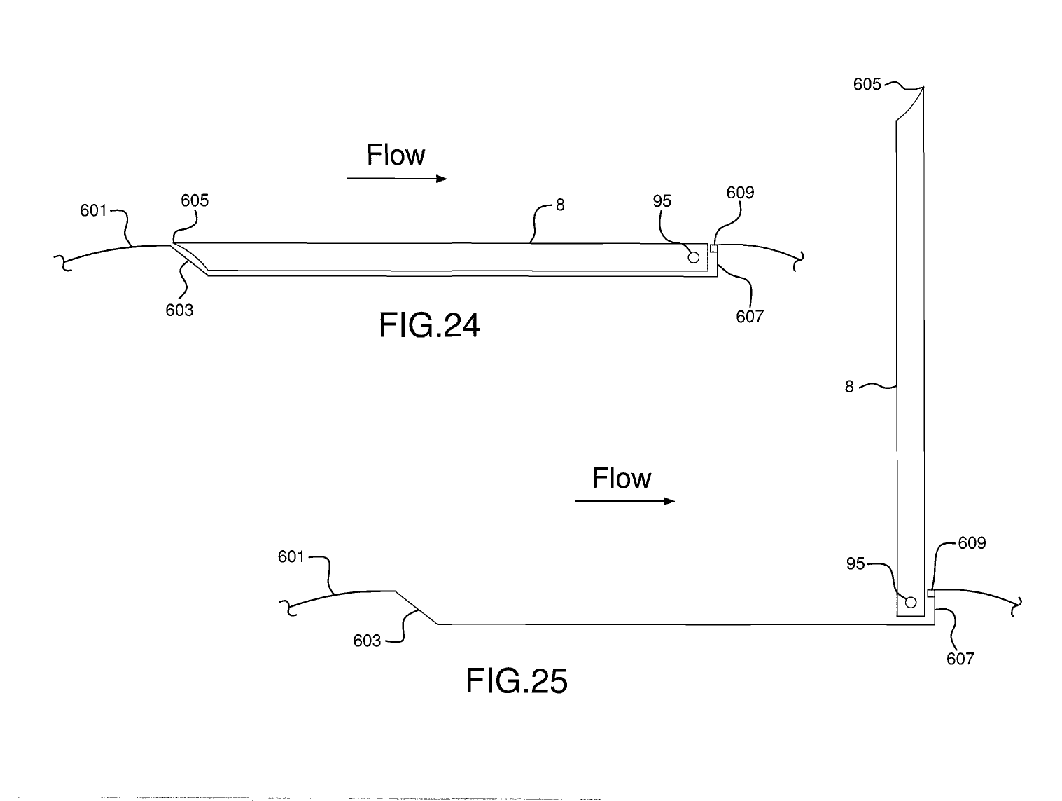

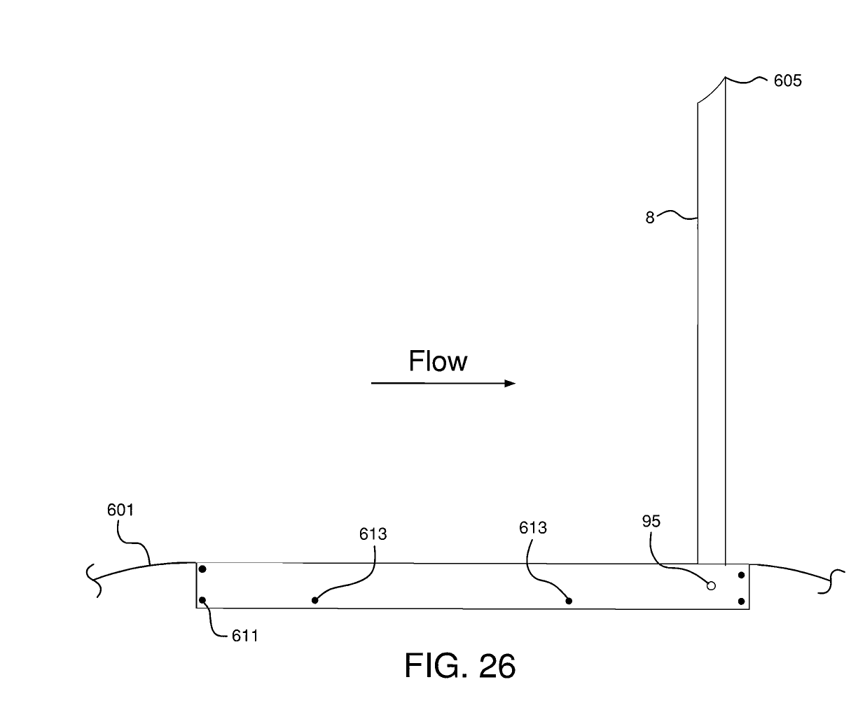

Various positions of the shutter 8 between fully open (FIG. 25) and closed (FIG. 24) for a shutter assembly 55 of an electricity generating assembly 151 are shown in FIGS. 22 and 23. A lip 605, as shown in FIGS. 22-26, may be formed at the end of a shutter 8 to capture the flow to facilitate opening the shutter. Recesses 603 formed in a drum 601 receive the shutters 8 when closed. The recesses 603 have a stop wall 607 to prevent further rotation of the shutter 8 about hinge 95, as shown in FIG. 25. A stopper 609 may be disposed on the stop wall 607 to further facilitate prevention of further shutter rotation. Plates 611 may be connected to the drum 601 by fasteners 613. The hinge 95 is secured to the plates 611, thereby securing the shutters 8 to the drum 601 of the electricity generating assembly 151. The shaft is 511 is disposed within the drum body 601 and connected to the generator housing 509, as shown in FIGS. 19, 22 and 23.

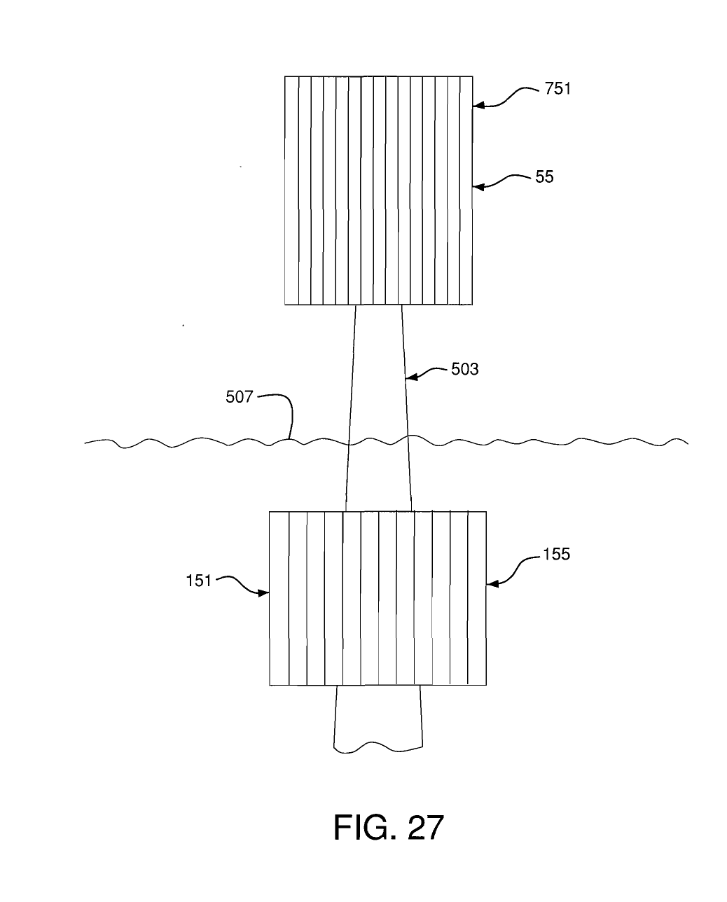

As shown in FIG. 27, a first electricity generating assembly 151 is self-contained such that all the components are housed within the shutter assembly 55. The first electricity generating assembly is mounted to a support 503 underwater to generate electricity by rotation of the fan blade by water currents. The support 503 may be an existing structure, such as a windmill. A second electricity generating assembly 751 (similar to the electricity generating assembly of FIG. 12) may be mounted to the support 503 above the water surface 507 to generate electricity by rotation of the fan blades by wind. Between the first and second electricity generating assemblies both wind and water currents are harnessed to generate electricity.

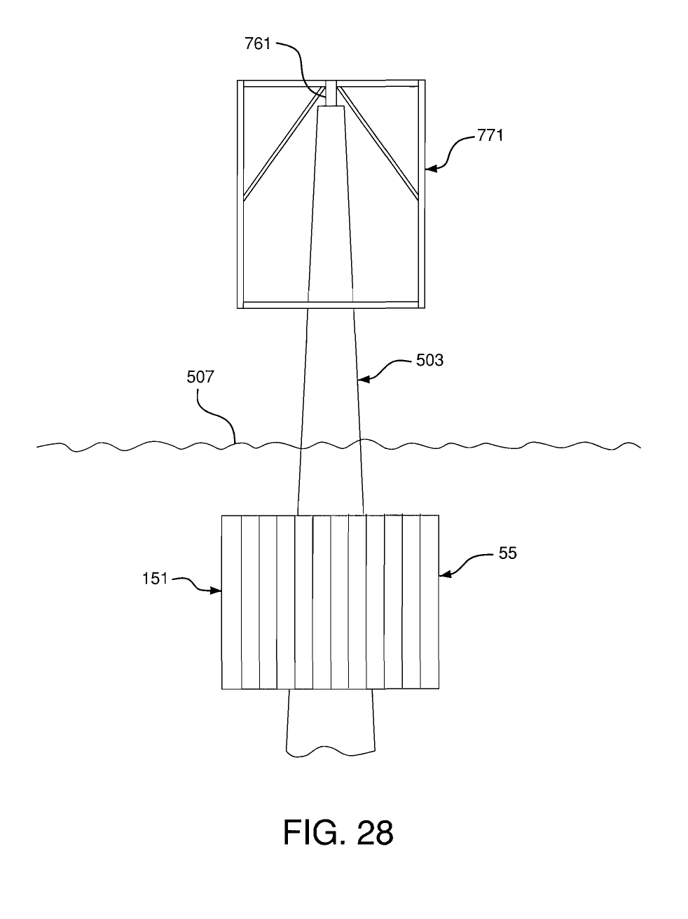

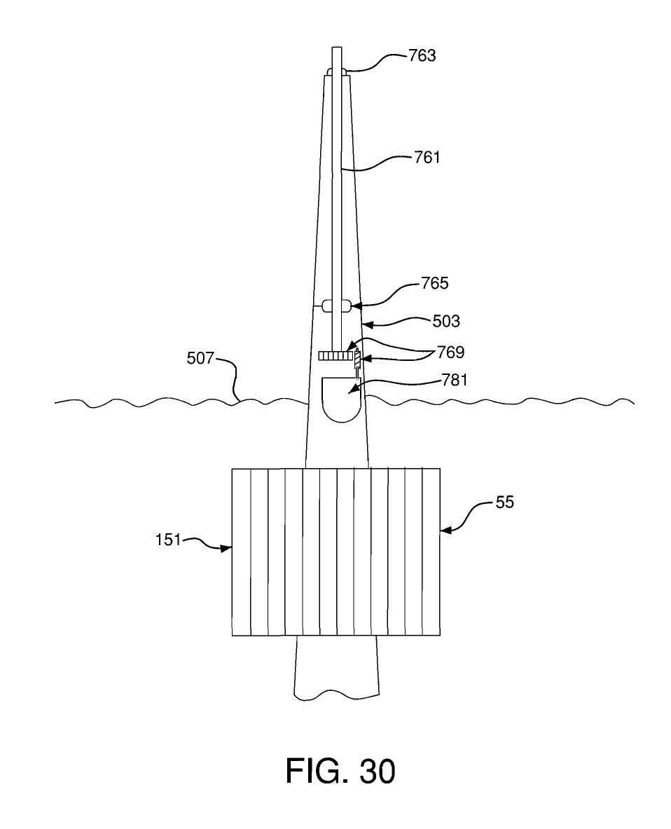

As shown in FIGS. 28 and 30, a shaft 761 is rotatably disposed within the support 503. A frame 771 is secured to the support 503 to facilitate mounting of the second electricity generating assembly 751 to the support 503. An upper bearings 763 and a lower bearing 765 facilitate rotatably mounting the shaft 761 within the support 503. A gear assembly 769 is disposed between the shaft 761 and a generator 781, which is disposed within the support 503. The generator 781 converts rotation of the fan blades into electricity. The rotation of the fan blades being transmitted to the shaft 761, which is in turn transmitted to the generator 781 by the gear assembly 769.

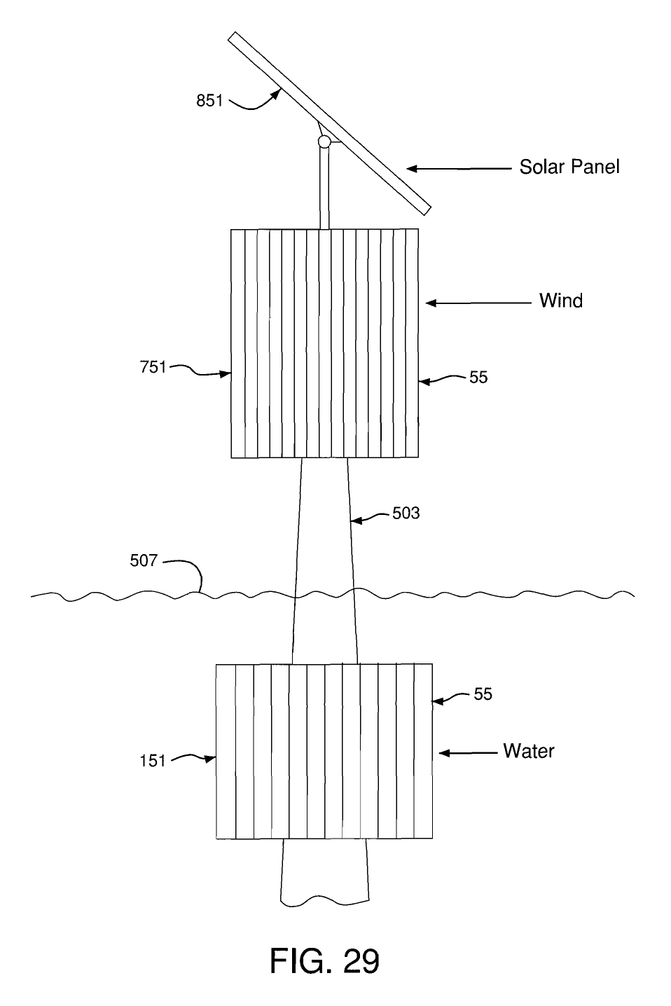

As shown in FIG. 29, a solar panel 851 is mounted to the support 503, thereby generating electricity based on solar power (by solar panel 851), on winds (second electricity generating assembly 751) and on water currents (first electricity generating assembly 151).

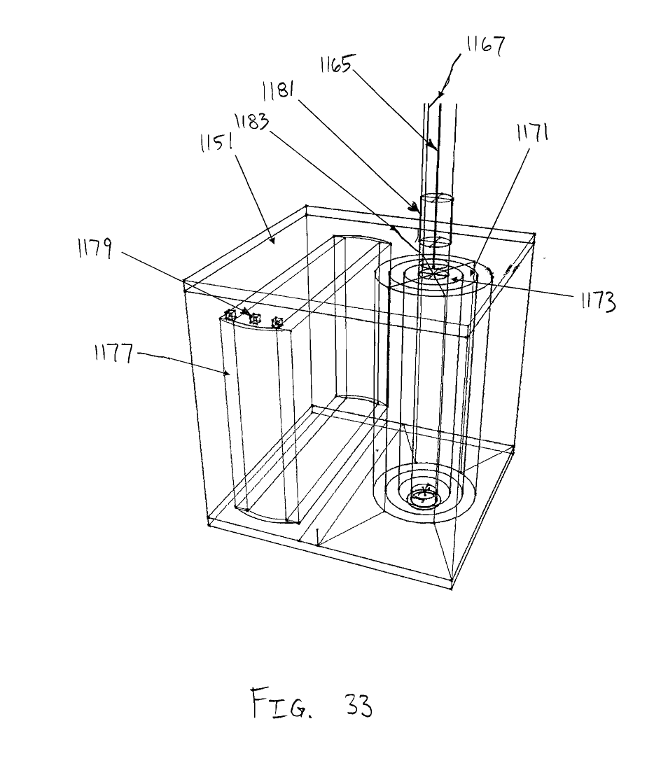

An electricity generating assembly 1121 according to another exemplary embodiment of the present invention is shown in FIG. 32. A first shaft 1123 extends between the bottom of a lower turbine 1125 and the top of an upper turbine 1127. The lower turbine 1125 is connected to a second shaft 1129 and extends between the bottom of the lower turbine 1125 and the top bearing of the lower turbine. Preferably, the second shaft 1129 is hollow such that the first shaft 1123 is received within the second shaft. An inner rotor 1135 is connected to the first shaft 1123, and an outer rotor 1137 is connected to the second shaft 1129. The inner rotor 1135 is disposed within the outer rotor 1137.

The upper turbine 1127 has a first plurality of fins or blades 1131 disposed on a cylindrical body 1132 and having a first curvature. The lower turbine 1125 has a second plurality of fins or blades 1133 disposed on a cylindrical body 1134 and having a second curvature opposite to that of the first plurality of fins 1131. The cylindrical bodies 1132 and 1134 preferably have solid perimeters to prevent wind or water from passing therethrough, thereby improving their efficiencies. The upper and lower turbines rotate in opposite directions. The upper and lower turbines 1127 and 1125 are disposed within a turbine housing 1141.

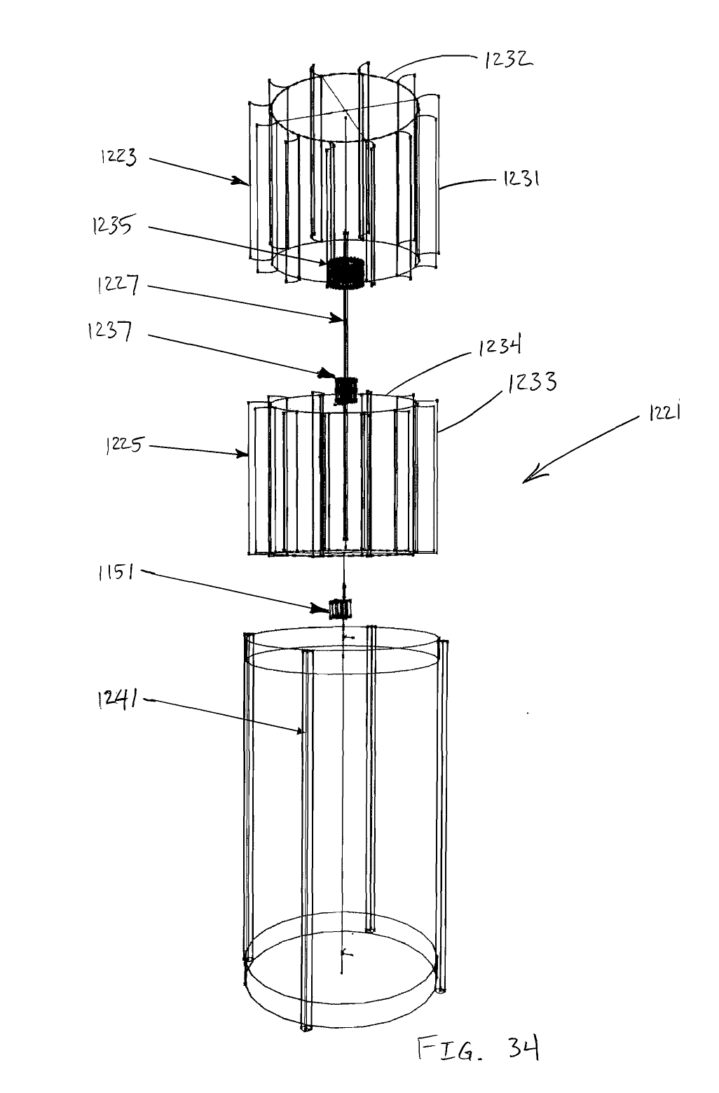

An electricity generating assembly 1221 according to another exemplary embodiment of the present invention is shown in FIGS. 34, 35 and 37. An upper turbine 1223 and a lower turbine 1225 are both connected to a shaft 1227. The upper turbine 1223 has a first plurality of fins or blades 1231 disposed on a cylindrical body 1232 and having a first curvature. The lower turbine 1225 has a second plurality of fins or blades 1233 disposed on a cylindrical body 1234 and having a second curvature opposite to that of the first plurality of fins 1231. The cylindrical bodies 1232 and 1234 preferably have solid perimeters to prevent wind or water from passing therethrough, thereby improving their efficiencies. The upper and lower turbines rotate in opposite directions. The upper and lower turbines 1223 and 1225 are disposed within a turbine housing 1241.

An outer rotor 1235 is disposed on the shaft 1227 and connected to the upper turbine 1227 such that rotation of the upper turbine results in rotation of the shaft 1227. An inner rotor 1237 is disposed on the shaft 1227 and connected to the lower turbine 1225 such that rotation of the lower turbine results in rotation of the shaft 1227.

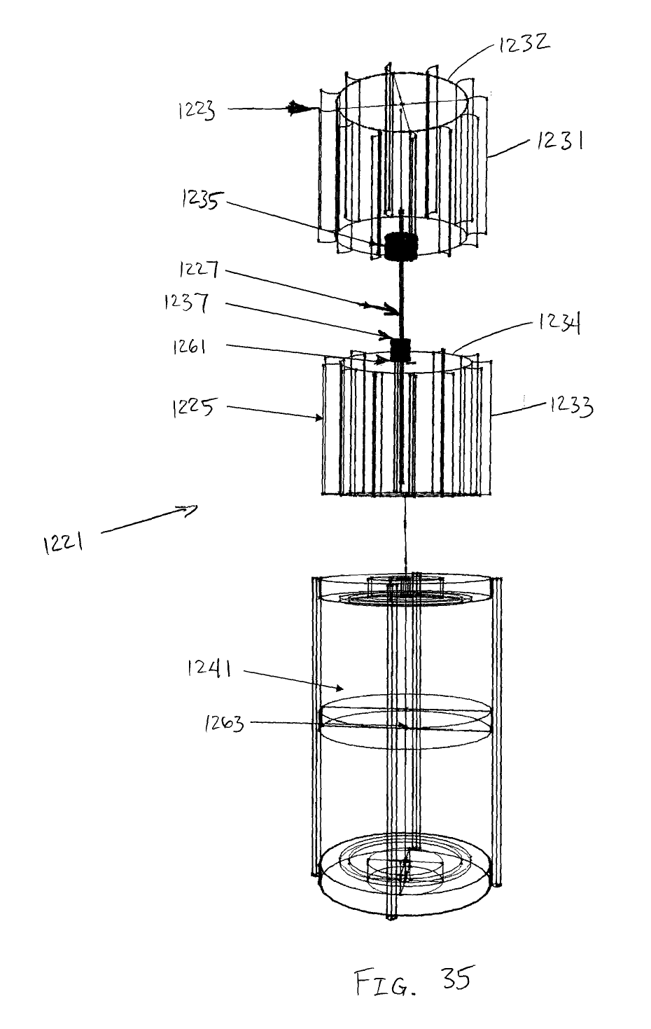

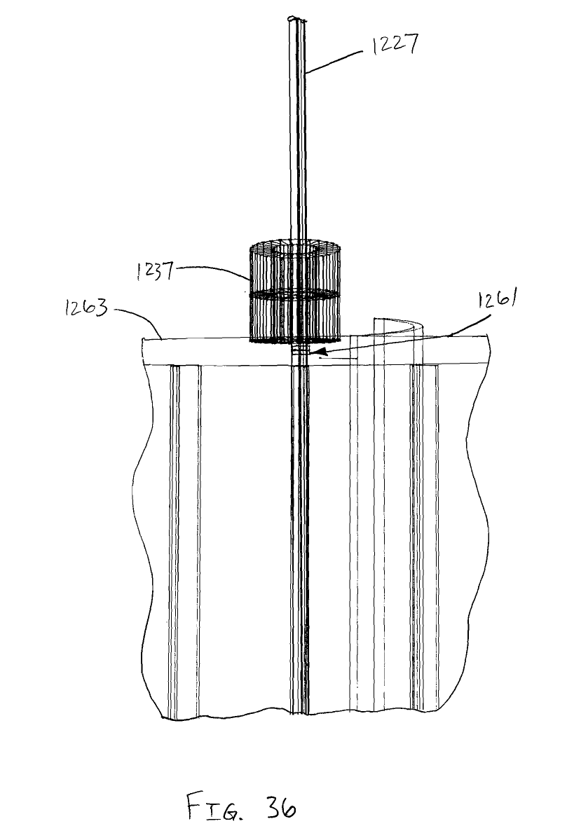

AC power can be delivered by rings and brushes, as shown in FIGS. 35 and 36 or through a rotating core transformer 1151 via turbine shaft, as shown in FIGS. 32 and 33. A slip ring assembly 1261 for delivering AC power is shown in FIGS. 35 and 36. The slip ring assembly 1261 is disposed on the shaft 1227. The slip ring assembly 1261 is disposed within a brush assembly 1263 such that electrical current is generated by rotation of the slip ring assembly 1261 within the brush assembly 1263.

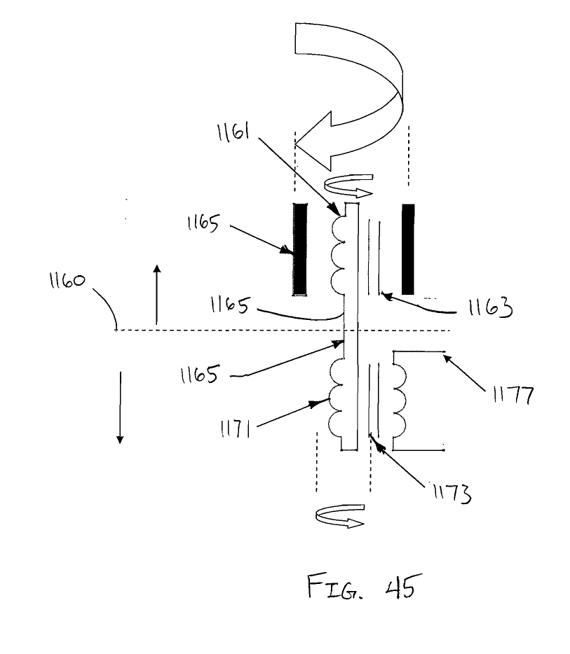

FIG. 45 is a schematic diagram illustrating the production of electricity in the electricity generating assembly 1121 of FIG. 32. Electricity is similarly produced in the other electricity generating assemblies having counter-rotating turbines. The portion of the diagram above the dashed line 1160 is housed in the turbine housing 1141, and the portion below the dashed line 1160 is housed in the rotating core transformer 1151. The outer rotor 1137 includes a magnet and the inner rotor includes a winding. As the outer rotor 1137 rotates by the inner rotor 1135, electrical current is induced into the windings 1161 disposed on an iron core 1163. The current is transmitted through a conductor 1165 that is connected to rotating coil 1171 in the rotating core transformer 1151, as shown in FIG. 33. The rotating coil 1171 induces a magnetic field within an iron core 1173 of the rotating core transformer 1151. The magnetic field within the rotating core transformer 1151 induces an electric current into the output coil 1177. Output lugs 1179 are connected to the output coil winding 1177 to provide a connection point to receive the generated electrical power.

An isolating coupling 1181 couples an output shaft 1167 of the electricity generating assembly 1121 with an input shaft 1183 of the rotating core transformer 1151. The isolating coupling allows the electricity generating assembly 1121 and the rotating core transformer 1151 to be easily separated from one another such that either unit can be worked on or replaced without affecting the other unit.

Lower wind speeds turbines cause turbines to rotate at a slower speed. Accordingly, using the counter-rotating upper and lower turbines of FIGS. 31, 34, 35 and 37, causes the power coils and field coils to be move at the equivalent of twice the rpm because the upper and lower turbines are rotating in opposite directions. This provides smoother DC current or higher frequency AC current from lower wind speeds. When using gears to increase the RPMs, half of the gear ratio is necessary because the upper and lower turbines are rotating in opposite directions. When electricity is taken from the generator of a stationary coil, the frequency is only half of what is being produced by the counter rotating generator in accordance with exemplary embodiments of the present invention. Thus, to harness the developed frequency, the electricity produced by either the slip rings and brushes or the rotating core transformer is tapped.

The momentum of the upper and lower turbines (or the upper and lower disks) rotating in opposite directions provides twice the mass of one disk rotating in relation to a stationary stator (power coil). Because force is equal to mass times velocity, a higher peak power is provided by the counter-rotating turbines compared to one disk (rotor) rotating at the same rpm. The counter-rotating turbines can both be placed at the bottom of the housing, at the top of the housing, top and bottom of the housing, center and bottom of the housing, or the top and center of the housing, depending on the installation to allow for servicing and efficient operation.

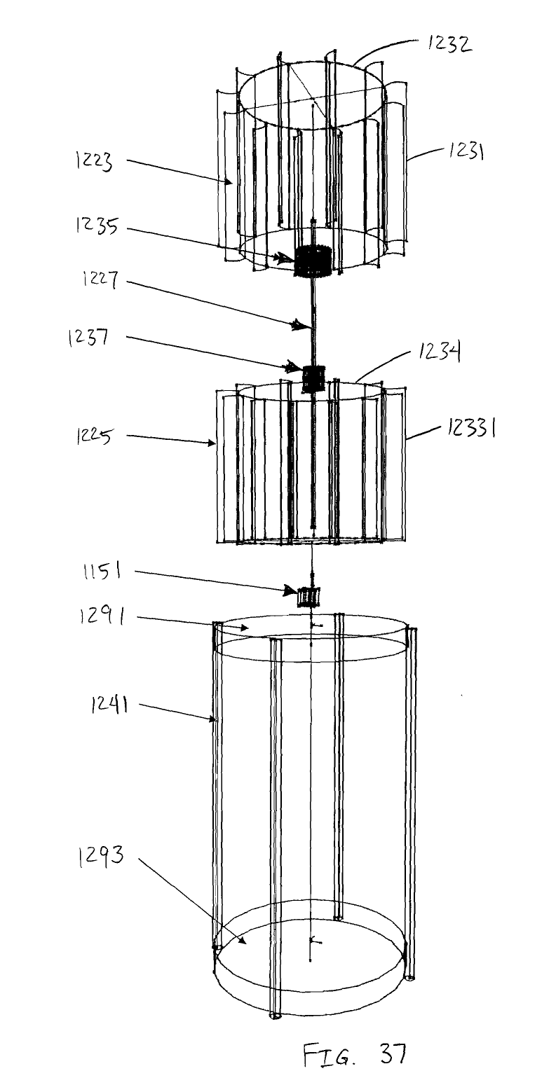

Inertia disks 1291 of various weights can be attached to each of the turbine assemblies, as shown in FIG. 37. An upper inertia disk 1291 is disposed proximal the top of the turbine housing 1241 and a lower inertia disk 1293 is disposed proximal the bottom of the turbine housing. The mass of the inertia disks is used to store kinetic energy from gusts of wind and to govern the speed of rotation of the turbine assemblies in high winds. The inertia disks can be disconnected from the turbines during low wind speeds. An electromagnetic clutch or magnetic field can be used to connect and disconnect the disks from their respective turbines. As shown in FIG. 38, an upper clutch 1292 controls connection of the upper inertia disk 1291 and a lower clutch 1294 controls operation of the lower inertia disk 1293.

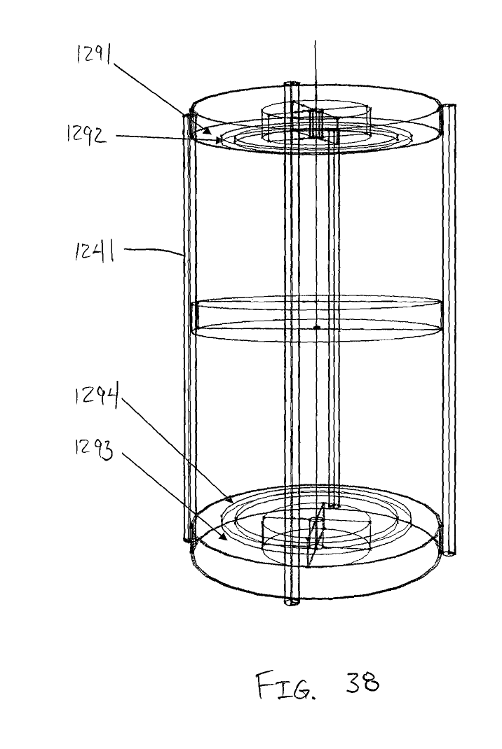

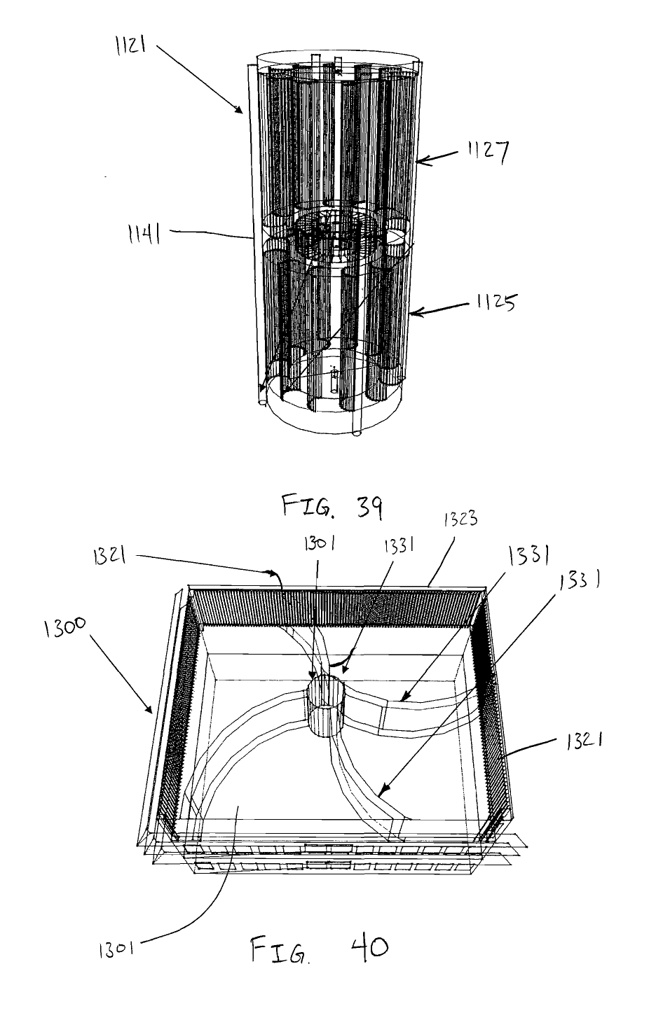

An assembled electricity generating assembly 1301 is shown in FIG. 39. The electricity generating assembly can be disposed on any floor of any building to generate electricity, as shown in FIG. 40. The floor 1311 of the building 1300 has a perimeter formed of movable shutters 1321. The shutters can be opened or closed depending on the wind conditions. Vanes 1331 are connected between the outer perimeter 1323 and the electricity generating assembly 1301 to guide wind to the electricity generating assembly.

Alternatively, an electricity generating assembly having counter-rotating turbines, as shown in FIGS. 32 and 34 for example, may be used.

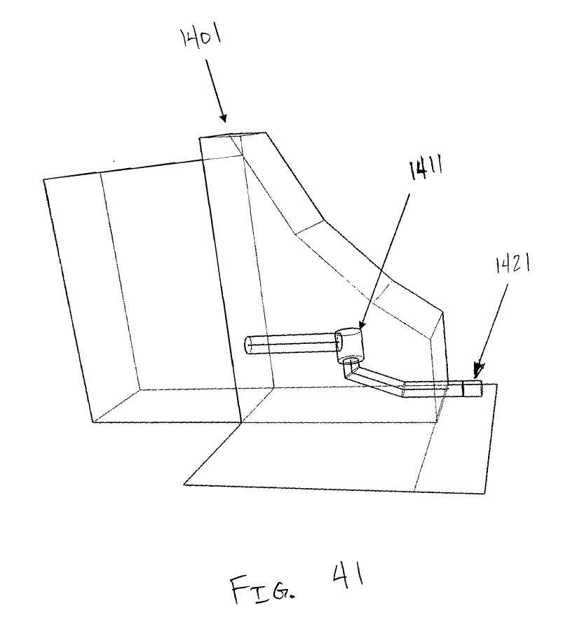

Another use for an electricity generating assembly 1421 according to any of the exemplary embodiments of the present invention is to generate electricity using water as the fluid medium. As shown in FIG. 41, the electricity generating assembly 1421 is connected to an existing generator 1411 of a dam 1401. The electricity generating assembly 1421 is disposed on the downstream side of the dam 1401 to receive discharged water. The position of the electricity generating assembly is positioned such that the backpressure seen by the existing generator 1411 is neutralized, i.e., substantially zero. The electricity generating assembly 1421 can be mounted on hydraulic rams 1435 such that the position of the electricity generating assembly is adjustable to ensure that there is no backpressure on the existing generator 1411. Accordingly, the efficiency of the existing generator 1411 is increased, while also creating additional energy from discharged water.

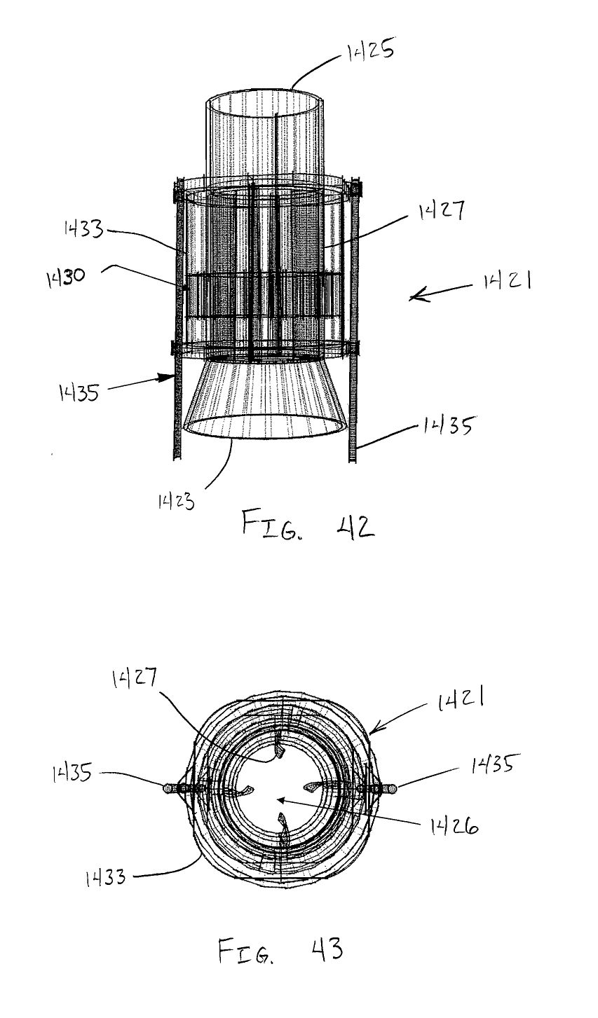

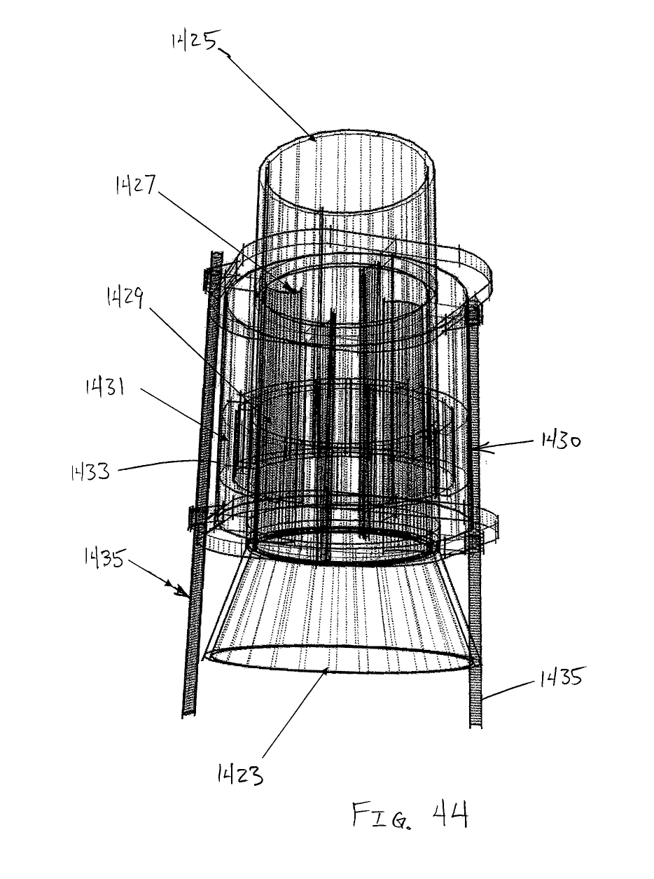

As shown in FIGS. 42-44, the electricity generating assembly 1421 has an inlet 1423 through which water enters the electricity generating assembly and an outlet 1425 through which water exits and a passageway 1426 therebetween. The water engages the turbine blades 1427 disposed in the passageway causing the blades to rotate. The blades 1427 are connected to a generator 1430 to produce electricity by rotation of the turbine blades 1427. The generator 1430 includes a rotor 1429 rotatable within a stator 1431, as shown in FIG. 44, thereby generating electricity. The blades 1427, rotor 1429 and stator 1431 are disposed within a housing 1433. The inlet 1423 is separated into upper and lower passages when using an electricity generating assembly having counter-rotating turbines, as shown in FIG. 32.

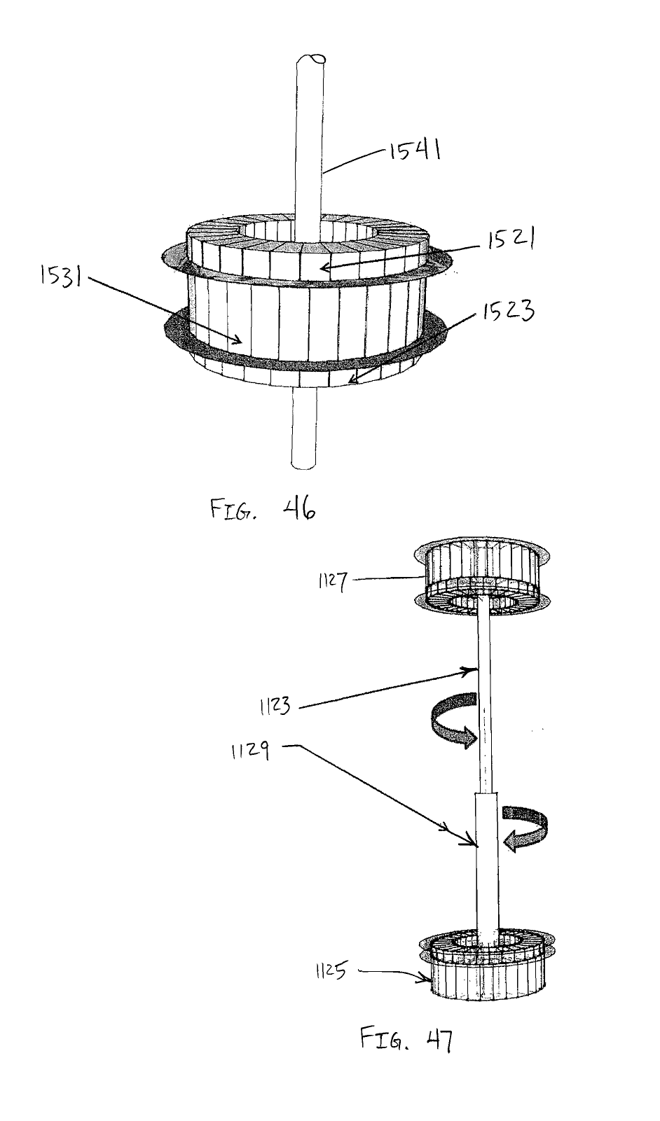

As shown in FIG. 46, counter-rotating magnets 1521 and 1523 rotate with respect to a stator 1531 to produce electrical current. A single shaft 1541 may be used to rotate the magnets 1521 and 1523, or first and second shafts 1123 and 1129 can be used as shown in FIG. 47.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electricity generating assembly, comprising:
a first turbine having a first plurality of fan blades;
a first rotor connected to said first turbine and rotatable with said first turbine;
a second turbine having a second plurality of fan blades;
a second rotor connected to said second turbine and rotatable with said second turbine; and
said first and second turbines being rotatably connected to a shaft such that rotation of the first and second turbines causes rotation of said shaft, said first and second turbines rotating in opposite directions.

2. The electricity generating assembly according to claim 1, wherein
said second rotor is disposed within said first rotor.

3. The electricity generating assembly according to claim 1, wherein
said first and second plurality of fan blades have opposite curvatures to facilitate said first and second turbines rotating in opposite directions.

4. The electricity generating assembly according to claim 1, wherein
said first and second turbines have solid outer perimeters to which said first and second plurality of fan blades are respectively connected to prevent passage of a fluid therethrough.

5. The electricity generating assembly according to claim 4, wherein
said fluid is air or water.

6. The electricity generating assembly according to claim 1, wherein
a conductor transmits current generated by the rotation of said first and second rotors to a rotating core transformer.

7. The electricity generating assembly according to claim 6, wherein
said conductor is disposed within said shaft.

8. The electricity generating assembly according to claim 6, wherein
a connection point on said rotating core transformer provides access to electrical power generated by said rotating core transformer from the received electrical current.

9. The electricity generating assembly according to claim 1, wherein
a first inertia disk is connected to said first turbine and a second inertia disk is connected to said second turbine.

10. An electricity generating assembly, comprising:
a first turbine having a first plurality of fan blades;
a first rotor connected to said first turbine and rotatable with said first turbine;
a first shaft connected to said first rotor and rotatable with said first rotor;
a second turbine having a second plurality of fan blades;
a second rotor connected to said second turbine and rotatable with said second turbine; and
a second shaft connected to said second rotor and rotatable with said second rotor;
wherein said first and second turbines rotate in opposite directions.

11. The electricity generating assembly according to claim 10, wherein
said second rotor is disposed within said first rotor.

12. The electricity generating assembly according to claim 10, wherein
said first and second plurality of fan blades have opposite curvatures to facilitate said first and second turbines rotating in opposite directions.

13. The electricity generating assembly according to claim 10, wherein
said first and second turbines have solid outer perimeters to which said first and second plurality of fan blades are respectively connected to prevent passage of a fluid therethrough.

14. The electricity generating assembly according to claim 13, wherein said fluid is air or water.

15. The electricity generating assembly according to claim 10, wherein
a conductor transmits current generated by the rotation of said first and second rotors to a rotating core transformer.

16. The electricity generating assembly according to claim 15, wherein
said conductor is disposed within said first or second shaft.

17. The electricity generating assembly according to claim 15, wherein
a connection point on said rotating core transformer provides access to electrical power generated by said rotating core transformer from the received electrical current.

18. The electricity generating assembly according to claim 10, wherein
a first inertia disk is connected to said first turbine and a second inertia disk is connected to said second turbine.

19. A method of generating electricity, comprising the steps of
connecting an electricity generating assembly to an existing generator disposed within a dam, the electricity generating assembly being disposed on a discharge side of the dam; and
adjusting a position of the electricity generating assembly such that a backpressure seen by the existing generator is substantially zero.

20. The method of generating electricity according to claim 19, wherein
the electricity generating assembly includes counter-rotating turbines.
